(19) United States
(12) Patent Application Publication
(10) Pub. No.: US 2022/0219671 A1
(43) Pub. Date: Jul. 14, 2022

(54) HYBRID VEHICLE

(71) Applicant: TOYOTA JIDOSHA KABUSHIKI KAISHA, Toyota-shi (JP)

(72) Inventor: Yuki OGAWA, Toyota-shi (JP)

(73) Assignee: TOYOTA JIDOSHA KABUSHIKI KAISHA, Toyota-shi (JP)

(21) Appl. No.: 17/525,276

(22) Filed: Nov. 12, 2021

(30) Foreign Application Priority Data
Jan. 14, 2021 (JP) 2021-004133

(51) Int. Cl. B60W 20/13

(52) U.S. Cl. CPC B60W 20/13; B60W 2510/244; B60W 2552/05

(57) ABSTRACT

A hybrid vehicle includes an internal combustion engine, a battery, an electric motor, and a controller. The controller is configured to set a traveling schedule to a destination by assigning any control mode out of a charge depleting mode and a charge sustaining mode to each of a plurality of traveling sections on a scheduled traveling route from a current position to the destination. The traveling sections include at least one of a first section, a second section, and a third section. The first section is a traveling section that requires traveling with the internal combustion engine stopped. When the traveling sections include the first section, the controller is configured to execute a suppression process for suppressing consumption of electric power in the battery as compared to a case where the traveling sections do not include the first section.

### CROSS-REFERENCE TO RELATED APPLICATION

This application claims priority to Japanese Patent Application No. 2021-004133 filed on Jan. 14, 2021, incorporated herein by reference in its entirety.

### BACKGROUND

### 1. Technical Field

The present disclosure relates to a hybrid vehicle.

### 2. Description of Related Art

In a hybrid vehicle including a motor generator serving as a drive source and an engine serving as an electric generator, any one of a plurality of control modes is selected and the vehicle is controlled in the selected control mode. Examples of the control modes include a charge depleting (CD) mode and a charge sustaining (CS) mode. In the CD mode, the vehicle continues to travel through an operation of a motor and electric power stored in an on-board battery is consumed while keeping the engine stopped to the extent possible. In the CS mode, the engine is activated more frequently than the CD mode and the vehicle travels while keeping the remaining charge level of the on-board battery in a predetermined range by using the engine and the motor generator.

When this hybrid vehicle travels toward a destination set by a user, switching control is executed to switch the control modes as appropriate depending on a condition on a traveling route.

For example, Japanese Unexamined Patent Application Publication No. 2014-151760 (JP 2014-151760 A) discloses a hybrid vehicle configured to set a traveling route to a destination and set an electric vehicle (EV) mode for motor-based traveling or a hybrid vehicle (HV) mode using an engine and a motor generator in each of a plurality of sections on the set traveling route except one or more sections behind the destination.

### SUMMARY

In the hybrid vehicle disclosed in JP 2014-151760 A, a traveling schedule is created so that the state of charge (SOC) of a traveling battery reaches zero when the vehicle arrives at the destination. Thus, overall running costs of the hybrid vehicle are reduced.

A power consumption of the battery in the traveling schedule may differ from an actual power consumption of the battery. Therefore, electric power in the battery may be exhausted and the vehicle may travel in the CS mode in a section where the vehicle is scheduled to travel in the CD mode. For example, when a scheduled traveling route includes a regulatory section where motor-based traveling is required while keeping the engine stopped and electric power in the battery is exhausted in the regulatory section, the engine may operate in the regulatory section.

The present disclosure provides a hybrid vehicle in which, when a scheduled traveling route includes a regulatory section, exhaustion of electric power in a battery can be suppressed in the regulatory section.

A hybrid vehicle according to one aspect of the present disclosure includes an internal combustion engine, a battery, an electric motor, and a controller. The electric motor is configured to generate a traveling drive force by using electric power stored in the battery. The controller is configured to set a traveling schedule to a destination by assigning any control mode out of a charge depleting (CD) mode and a charge sustaining (CS) mode to each of a plurality of traveling sections on a scheduled traveling route from a current position to the destination. The traveling sections include at least one of a first section, a second section, and a third section. The first section is a traveling section that requires traveling with the internal combustion engine stopped. The second section is a traveling section that requires assignment of the CD mode. The third section is a traveling section except the first section and the second section. The controller is configured to, when setting the traveling schedule, assign the CD mode in order of the first section, the second section, and the third section until a remaining charge level of the battery reaches a value smaller than a sum of energy consumptions in traveling sections where the CD mode is assigned, and assign the CS mode to traveling sections where the CD mode is not assigned. The controller is configured to execute traveling assistance control for switching the control modes in accordance with the traveling schedule. The controller is configured to, when the traveling sections include the first section, execute a suppression process for suppressing consumption of the electric power in the battery as compared to a case where the traveling sections do not include the first section.

In the hybrid vehicle according to the one aspect of the present disclosure, the controller executes the suppression process for suppressing the consumption of the electric power in the battery when the scheduled traveling route from the current position to the destination includes the first section (for example, the regulatory section). Therefore, the power consumption of the battery is suppressed when the scheduled traveling route includes the first section. Thus, exhaustion of the electric power in the battery can be suppressed in the first section. Accordingly, operation of the internal combustion engine can be suppressed in the first section.

In the hybrid vehicle according to the one aspect of the present disclosure, the suppression process may include a first process for setting the traveling schedule by reassigning the CS mode to at least one of the traveling sections where the CD mode is assigned.

In the hybrid vehicle according to the one aspect of the present disclosure, the CS mode is reassigned to at least one of the traveling sections where the CD mode is assigned. That is, the control mode of at least one of the traveling sections where the CD mode is assigned is changed from the CD mode to the CS mode. Since the number of traveling sections in the CD mode decreases and the number of traveling sections in the CS mode increases, the power consumption of the battery can be suppressed during the traveling in accordance with the traveling schedule. Thus, the exhaustion of the electric power in the battery can be suppressed in the first section, and the operation of the internal combustion engine can be suppressed in the first section.

In the hybrid vehicle according to the one aspect of the present disclosure, the controller may be configured to, when the remaining charge level of the battery is smaller than the sum, set the traveling schedule through the first process by reassigning the CS mode to a traveling section where the CD mode is assigned last among the traveling sections where the CD mode is assigned in the order of the first section, the second section, and the third section.

In the hybrid vehicle according to the one aspect of the present disclosure, when setting the traveling schedule through the first process, the controller reassigns the CS mode to the traveling section where the CD mode is set last, that is, a traveling section that is lowest in the rank of assignment among the traveling sections where the CD mode is set. Since the number of traveling sections in the CD mode decreases by one and the number of traveling sections in the CS mode increases by one, the power consumption of the battery can be suppressed during the traveling in accordance with the traveling schedule. Thus, the exhaustion of the electric power in the battery can be suppressed in the first section, and the operation of the internal combustion engine can be suppressed in the first section.

In the hybrid vehicle according to the one aspect of the present disclosure, the suppression process may include a second process for suspending the traveling assistance control when a suspension condition is satisfied. The controller may be configured to set the control mode to the CS mode when the traveling sections include the first section and a current traveling section is not the first section during suspension of the traveling assistance control through the second process.

In the hybrid vehicle according to the one aspect of the present disclosure, the control mode is set to the CS mode when the scheduled traveling route includes the first section and the current traveling section is not the first section during the suspension of the traveling assistance control through the second process. By setting the control mode to the CS mode in the traveling section except the first section, consumption of the electric power in the battery is suppressed in the traveling section except the first section. Therefore, the electric power in the battery can be saved, and exhaustion of the electric power in the battery can be suppressed in the first section on the scheduled traveling route. Thus, the operation of the internal combustion engine can be suppressed in the first section.

In the hybrid vehicle according to the one aspect of the present disclosure, the controller may be configured to set the control mode to the CD mode when the current traveling section is the first section during the suspension of the traveling assistance control through the second process.

In the hybrid vehicle according to the one aspect of the present disclosure, the control mode is set to the CD mode when the hybrid vehicle is traveling in the first section during the suspension of the traveling assistance control through the second process. Thus, the operation of the internal combustion engine can be suppressed in the first section even during the suspension of the traveling assistance control.

In the hybrid vehicle according to the one aspect of the present disclosure, the suspension condition may include at least one of a condition that the hybrid vehicle enters an off-road section and a condition that a temperature of the battery is lower than a threshold temperature.

In the off-road section, the consumption of the electric power in the battery may be difficult to predict. When the temperature of the battery is lower than the threshold temperature, the charging/discharging efficiency of the battery may decrease and the consumption of the electric power in the battery may be difficult to predict. In the hybrid vehicle according to the one aspect of the present disclosure, the suspension condition is set to the case where the consumption of the electric power in the battery is difficult to predict. Thus, it is possible to suppress power consumption of the battery that is larger than expected.

In the hybrid vehicle according to the one aspect of the present disclosure, the suppression process may include a third process for calculating zero as an energy consumption in a traveling section that is the first section where regenerative energy is larger than a power consumption of the battery when calculating the energy consumptions in the traveling sections.

The calculation of zero as the energy consumption in the section corresponding to the first section and the regenerative section may be translated into calculation of smaller regenerative power. By calculating smaller regenerative power in the first section, it is possible to set a traveling schedule in which the electric power in the battery has a reserve capacity. In the hybrid vehicle according to the one aspect of the present disclosure, the exhaustion of the electric power in the battery can be suppressed in the first section by traveling in accordance with this traveling schedule. Thus, the operation of the internal combustion engine can be suppressed in the first section.

In the hybrid vehicle according to the one aspect of the present disclosure, the traveling sections may include a plurality of the first sections, and the suppression process may include a fourth process for adding a predetermined margin to an energy consumption in at least one of the first sections when calculating the energy consumptions in the traveling sections.

In the hybrid vehicle according to the one aspect of the present disclosure, the predetermined margin is added to the energy consumption in at least one of the first sections, thereby setting a traveling schedule in which the electric power in the battery has a reserve capacity. The exhaustion of the electric power in the battery can be suppressed in the first section by traveling in accordance with this traveling schedule. Thus, the operation of the internal combustion engine can be suppressed in the first section.

In the hybrid vehicle according to the one aspect of the present disclosure, the controller may be configured to add the predetermined margin to an energy consumption in the first section closest to the current position in the fourth process.

In the hybrid vehicle according to the one aspect of the present disclosure, the predetermined margin is added to the energy consumption in the first section closest to the current position, thereby setting a traveling schedule in which the electric power in the battery has a reserve capacity. The exhaustion of the electric power in the battery can be suppressed in the first section by traveling in accordance with this traveling schedule. Thus, the operation of the internal combustion engine can be suppressed in the first section.

In the hybrid vehicle according to the one aspect of the present disclosure, the CD mode may be a control mode for consuming the electric power stored in the battery. The CS mode may be a control mode for keeping a power storage amount of the battery within a predetermined range.

According to the present disclosure, when the scheduled traveling route includes the regulatory section, the exhaustion of the electric power in the battery can be suppressed in the regulatory section.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is an overall configuration diagram illustrating an example of a hybrid vehicle according to a first embodiment;

FIG. 2 is a diagram for describing priority levels to be set to traveling sections;

FIG. 3 is a flowchart illustrating a processing procedure of traveling assistance control;

FIG. 4 is a flowchart illustrating a procedure of a first setting process of S7;

FIG. 5 is a flowchart illustrating a procedure of a second setting process of S8;

FIG. 6 is a flowchart illustrating a processing procedure of traveling assistance control according to a second embodiment;

FIG. 7 is a flowchart illustrating a procedure of a third setting process of S21;

FIG. 8 is a flowchart illustrating details of a process of S30;

FIG. 9 is a flowchart illustrating a processing procedure of traveling assistance control in Modified Example 1;

FIG. 10 is a flowchart illustrating a processing procedure of traveling assistance control according to a third embodiment;

FIG. 11 is a flowchart illustrating a procedure of a fourth setting process of S64;

FIG. 12 is a diagram for describing a process for setting a traveling schedule again; and

FIG. 13 is a flowchart illustrating a processing procedure of traveling assistance control in Modified Example 2.

### DETAILED DESCRIPTION OF EMBODIMENTS

Embodiments of the present disclosure are described below in detail with reference to the drawings. In the drawings, the same or corresponding parts are represented by the same reference symbols to omit repetitive description.

### First Embodiment

### Overall Configuration

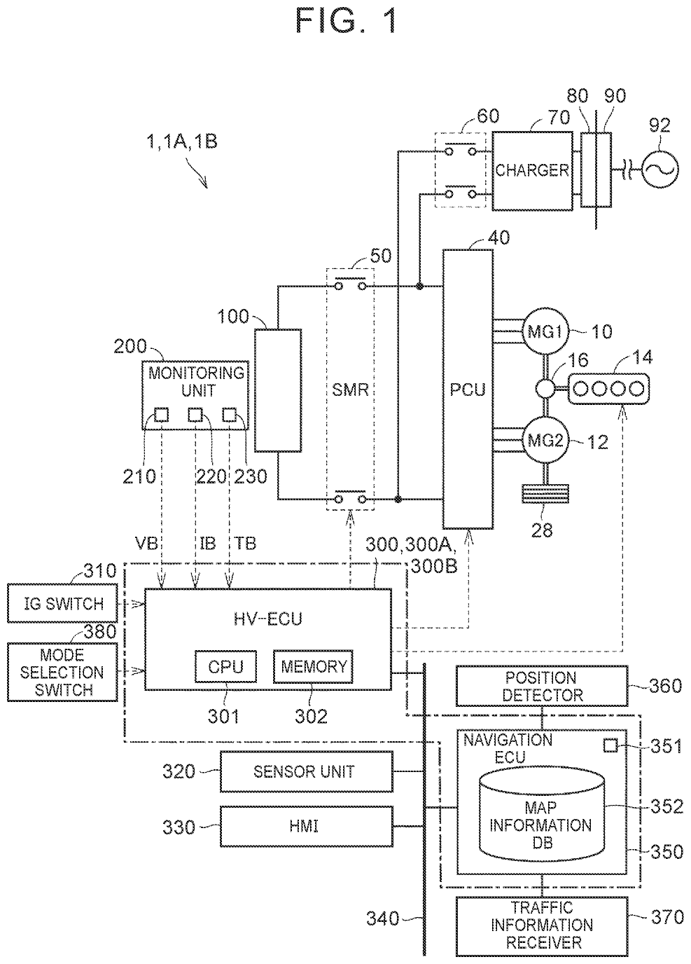

FIG. 1 is an overall configuration diagram illustrating an example of a hybrid vehicle according to a first embodiment. Referring to FIG. 1, a hybrid vehicle (hereinafter also referred to simply as “vehicle”) 1 is a so-called series-parallel (split) hybrid vehicle. The vehicle 1 is not limited to the series-parallel hybrid vehicle, and may be, for example, a parallel or series hybrid vehicle. The vehicle 1 can externally charge an on-board battery (battery 100 in FIG. 1) by using electric power supplied from a power supply outside the vehicle (external power supply 92 in FIG. 1).

Referring to FIG. 1, the vehicle 1 includes a first motor generator (hereinafter referred to also as “first MG”) 10, a second motor generator (hereinafter referred to also as “second MG”) 12, an engine 14, a power split device 16, driving wheels 28, a power control unit (PCU) 40, a system main relay (SMR) 50, a charging relay 60, a charger 70, an inlet 80, the battery 100, a monitoring unit 200, an HV electronic control unit (ECU) 300, an ignition (IG) switch 310, a sensor unit 320, a human machine interface (HMI) 330, a navigation ECU 350, a position detector 360, a traffic information receiver 370, and a mode selection switch 380.

Each of the first MG 10 and the second MG 12 is a three-phase alternating current (AC) rotating electrical machine such as a permanent magnet synchronous motor including a rotor having embedded permanent magnets. Each of the first MG 10 and the second MG 12 has functions of an electric motor (motor) and an electric generator (generator). The first MG 10 and the second MG 12 are connected to the battery 100 via the PCU 40.

For example, the first MG 10 is driven by an inverter in the PCU 40 and rotates an output shaft of the engine 14 to start the engine 14. The first MG 10 generates electric power by receiving power of the engine 14. The electric power generated by the first MG 10 is stored in the battery 100 via the PCU 40.

For example, the second MG 12 is driven by the inverter in the PCU 40 while the vehicle 1 is traveling. Power of the second MG 12 is transmitted to the driving wheels 28 via power transmission gears (not illustrated) such as a differential gear and a speed reducing gear. For example, while the vehicle 1 is braking, the second MG 12 is driven by the driving wheels 28 and operates as the electric generator to execute regenerative braking. Electric power generated by the second MG 12 is stored in the battery 100 via the PCU 40.

The engine 14 is a publicly known internal combustion engine configured to output power by burning fuel of a gasoline engine or a diesel engine (gasoline or light oil). Operating conditions of the engine 14 such as a throttle opening degree (intake amount), a fuel supply amount, and an ignition timing are electrically controllable by the HV-ECU 300. For example, the HV-ECU 300 controls a fuel injection amount, an ignition timing, and an intake air amount of the engine 14 to cause the engine 14 to operate at a target rotation speed and a target torque set based on conditions of the vehicle 1.

The power split device 16 splits a path of the power of the engine 14 into a path along which the power is transmitted to the driving wheels 28 and a path along which the power is transmitted to the first MG 10. For example, the power split device 16 is a planetary gearing mechanism including a sun gear, a ring gear, pinion gears, and a carrier.

The PCU 40 is a power converter configured to convert electric power between the battery 100 and the first MG 10 or between the battery 100 and the second MG 12 based on a control signal from the HV-ECU 300. The PCU 40 includes an inverter and a converter (both of which are not illustrated). The inverter drives the first MG 10 or the second MG 12 by converting direct current (DC) power from the battery 100 into AC power. The converter adjusts a voltage level of the DC power to be supplied from the battery 100 to the inverter.

The SMR 50 is electrically connected between the battery 100 and the PCU 40. The SMR 50 is closed or opened under control based on a control signal from the HV-ECU 300.

The battery 100 is mounted on the vehicle 1 as a driving electric power supply (that is, a power source) of the vehicle 1. The battery 100 includes a plurality of stacked batteries. The battery is a secondary battery such as a nickel-metal hydride battery or a lithium ion battery. The battery may be a battery containing a liquid electrolyte or a solid electrolyte (solid-state battery) between a positive pole and a negative pole. The battery 100 may be any rechargeable DC power supply, and may be a large-capacity capacitor. The battery 100 is charged with electric power generated through a power generating operation using the first MG 10 and the engine 14 or through regenerative braking in the second MG 12, and is discharged through a driving operation of the first MG 10 or the second MG 12.

The monitoring unit 200 monitors conditions of the battery 100. For example, the monitoring unit 200 includes a voltage sensor 210, a current sensor 220, and a temperature sensor 230. The voltage sensor 210 detects a voltage VB between terminals of the battery 100. The current sensor 220 detects a current IB input to or output from the battery 100. The temperature sensor 230 detects a temperature TB of the battery 100. The sensors output detection results to the HV-ECU 300.

The charging relay 60 is electrically connected between the SMR 50 and the inlet 80. The charging relay 60 is closed or opened under control based on a control signal from the HV-ECU 300.

The charger 70 is electrically connected between the charging relay 60 and the inlet 80. Examples of the charger 70 include an AC/DC converter (inverter). The charger 70 converts AC power supplied from the external power supply 92 via the inlet 80 into DC power, and outputs the DC power to the charging relay 60. The charger 70 is controlled based on a control signal from the HV-ECU 300.

The operation of the charger 70 is not particularly limited to the AC/DC conversion. When DC power is supplied from the inlet 80 to the charger 70, the charger 70 may operate as a DC/DC converter.

A connector 90 is insertable into the inlet 80 along with mechanical coupling such as fitting. Along with the insertion of the connector 90 into the inlet 80, electrical connection between the vehicle 1 and the external power supply 92 is secured. When the SMR 50 and the charging relay 60 are closed, electric power of the external power supply 92 can be supplied to the battery 100 via the charger 70 and the charging relay 60.

The HV-ECU 300 includes a central processing unit (CPU) 301, a memory 302, and an input/output port (not illustrated). The memory 302 includes a read only memory (ROM) and a random access memory (RAM), and stores, for example, programs to be executed by the CPU 301. The CPU 301 executes the programs stored in the ROM by loading the programs on the RAM. The CPU 301 executes predetermined arithmetic processing based on various signals input through the input/output port (for example, signals received from the monitoring unit 200, the IG switch 310, the sensor unit 320, and the mode selection switch 380) and information stored in the memory 302, and controls the devices in the vehicle 1 (such as the engine 14, the PCU 40, the SMR 50, the charging relay 60, the charger 70, and the HMI 330) based on a result of the arithmetic processing. Various types of control to be executed by the HV-ECU 300 may be processed not only by software but also by dedicated hardware (electronic circuit).

For example, during driving of the vehicle 1, the HV-ECU 300 calculates a state of charge (SOC) indicating the remaining charge level of the battery 100 by using detection results from the monitoring unit 200. The SOC is a percentage of the ratio of a current power storage amount of the battery 100 to a full-charge power storage amount. Various publicly known methods such as summation of current values (Coulomb-counting) and estimation of an open circuit voltage (OCV) may be employed as an SOC calculation method.

The HV-ECU 300 is connected to the sensor unit 320, the HMI 330, and the navigation ECU 350 via a communication bus 340. The position detector 360 and the traffic information receiver 370 are connected to the navigation ECU 350.

For example, the sensor unit 320 includes an accelerator pedal sensor, a vehicle speed sensor, and a brake pedal sensor. The accelerator pedal sensor detects an operation amount of an accelerator pedal operated by a user. The vehicle speed sensor detects a vehicle speed of the vehicle 1. The brake pedal sensor detects an operation amount of a brake pedal operated by the user. The sensors output detection results to the HV-ECU 300.

The HMI 330 provides the user with information for assisting driving of the vehicle 1. For example, the HMI 330 is a touch panel display provided in a cabin of the vehicle 1, including a loudspeaker. For example, the HMI 330 provides (notifies) the user with (about) various types of information by outputting visual information (graphical information and text information) and audio information (voice information and sound information).

The HMI 330 functions as a display to receive a current position of the vehicle 1 and map information and traffic jam information on an area around the current position from the navigation ECU 350 via the communication bus 340 and display the current position of the vehicle 1 together with the map information and the traffic jam information on the area around the current position.

The HMI 330 also functions as a touch panel operable by the user. The user touches the touch panel to change a scale of a displayed map or input a destination of the vehicle 1. When the destination is input to the HMI 330, information on the destination is transmitted to the navigation ECU 350 via the communication bus 340.

The devices connected to the communication bus 340 may communicate with each other through controller area network (CAN) communication via the communication bus 340 or through wireless communication in place of or in addition to the communication bus 340.

The navigation ECU 350 includes a CPU 351 and a memory 352. The CPU 351 and the memory 352 are similar to the CPU 301 and the memory 302, and therefore their detailed description is not repeated. The memory 352 has a map information database (DB). The navigation ECU 350 outputs a current position of the vehicle 1 and map information and traffic jam information on an area around the current position to the HMI 330 and the HV-ECU 300 based on various types of information stored in the map information DB, various types of information detected by the position detector 360, and various types of information received from the traffic information receiver 370.

In every predetermined period (for example, every time interval of several minutes), the navigation ECU 350 outputs, to the HV-ECU 300, map information and road traffic information on a scheduled traveling route from a current position of the vehicle 1 to a destination (hereinafter also referred to collectively as “preview information”). The navigation ECU 350 outputs the preview information to the HV-ECU 300 when the destination is input through an operation on the HMI 330 and information on the destination is received from the HMI 330. As indicated by a box of a long dashed short dashed line in FIG. 1, the HV-ECU 300 and the navigation ECU 350 of this embodiment are examples of “controller” of the present disclosure.

The map information DB stores map information. The map information contains data related to “nodes” indicating, for example, an intersection and a dead end, “links” connecting the nodes, and “facilities” (building and parking area) along the links. The map information also contains positional information on each node, distance information on each link, road category information on each link (information on a downtown, a minor street, an expressway, or an ordinary road), load information on each link (speed information including an average vehicle speed on the link that can be calculated based on a speed limit, power information including average traveling power required to travel along the link at the average vehicle speed, and gradient information including an average gradient on the link), and regulation information on each link (information indicating whether a regulatory section described later is present). The map information is not limited to information acquired by being read from the map information DB, and may be information sequentially acquired through communication with an external database in addition to or in place of the information acquired from the map information DB.

For example, the position detector 360 acquires a current position of the vehicle 1 based on a signal (radio wave) from a Global Positioning System (GPS) satellite, and outputs a signal indicating the current position of the vehicle 1 to the navigation ECU 350. The method for acquiring the current position of the vehicle 1 may be a method that involves acquiring the current position by using a position detecting satellite other than the GPS satellite, or a method that involves acquiring the current position by exchanging predetermined information with an access point of a cellular base station or a wireless local area network (LAN).

The traffic information receiver 370 receives predetermined road traffic information. Examples of the predetermined road traffic information include road traffic information provided by frequency modulation (FM) multiplex broadcasting, and road traffic information collected from a probe vehicle or a probe center. The road traffic information contains at least traffic jam information, and may also contain traffic control information or parking information. For example, the road traffic information is updated at intervals of several minutes.

The mode selection switch 380 can select any one of a plurality of control modes. The control modes are described later. In response to a user's operation, the mode selection switch 380 transmits, to the HV-ECU 300, a signal indicating that the mode selection switch 380 is operated.

In this embodiment, the vehicle 1 is controlled by the HV-ECU 300 in any one of the control modes. The control modes include a charge depleting (CD) mode and a charge sustaining (CS) mode. The CD mode is a control mode in which the vehicle 1 continues to travel through an operation of the motor using electric power discharged from the battery 100 and therefore the electric power stored in the battery 100 is consumed while keeping the engine 14 stopped to the extent possible. The CS mode is a control mode in which the engine 14 is activated more frequently than the CD mode and the vehicle 1 travels while keeping the remaining charge level (SOC) of the battery 100 in a predetermined range by charging and discharging the battery 100 using the engine 14, the first MG 10, and the second MG 12.

For example, when the CD mode or the CS mode is assigned as the control mode, the HV-ECU 300 controls the engine 14, the battery 100, the first MG 10, and the second MG 12 in the assigned control mode.

For example, when no scheduled traveling route is set (that is, no destination is set), the HV-ECU 300 controls the engine 14, the first MG 10, and the second MG 12 in the CD mode until the SOC of the battery 100 reaches a value smaller than a predetermined value. That is, the HV-ECU 300 executes motor-based traveling by using the second MG 12 while keeping the engine 14 stopped. The predetermined value is set so as not to advance deterioration of the battery 100, and indicates, for example, an SOC corresponding to a value obtained by adding a specified value to a lower limit value of the power storage amount of the battery 100. For example, the predetermined value is preset based on specifications of the battery 100 and results of experiment or simulation. For example, when a driving force required in the vehicle 1 increases through an increase in a depression amount of the accelerator pedal though the CD mode is selected, the HV-ECU 300 may start the engine 14 by using the first MG 10, and cause the vehicle 1 to travel by using the engine 14 and the second MG 12.

When the SOC of the battery 100 is smaller than the predetermined value, the HV-ECU 300 switches the CD mode to the CS mode, and controls the engine 14, the battery 100, the first MG 10, and the second MG 12 in the CS mode. That is, the HV-ECU 300 causes the vehicle 1 to travel by using the second MG 12 while generating electric power by using the first MG 10 with the power of the engine 14 so that the SOC of the battery 100 falls within the predetermined range with respect to an SOC of the battery 100 when the control modes are switched. For example, when the SOC of the battery 100 is larger than an upper limit value of the predetermined range though the CS mode is selected, the HV-ECU 300 may execute the motor-based traveling by using the second MG 12 while keeping the engine 14 stopped.

For example, when the mode selection switch 380 is operated to request the CS mode, the HV-ECU 300 selects the CS mode as the control mode. For example, when the mode selection switch 380 is operated to request the CD mode, the HV-ECU 300 selects the CD mode as the control mode under a condition that the SOC of the battery 100 is equal to or larger than the predetermined value. When the CD mode is selected by operating the mode selection switch 380 but the SOC of the battery 100 is smaller than the predetermined value, the HV-ECU 300 switches the CD mode to the CS mode.

### Traveling Assistance Control

When a scheduled traveling route is set (a destination is set), the HV-ECU 300 executes traveling assistance control for setting a traveling schedule from a current position to the destination and causing the vehicle 1 to travel by switching the CD mode and the CS mode in accordance with the traveling schedule.

Specifically, when a destination is set by the user and the predetermined period (for example, several minutes) elapses after the destination is set, the navigation ECU 350 sets a scheduled traveling route from a current position of the vehicle 1 to the destination. The navigation ECU 350 sets a scheduled traveling route that satisfies conditions such as a traveling distance, whether to use an expressway, and whether a traffic jam occurs. When the scheduled traveling route is set, the navigation ECU 350 transmits, to the HV-ECU 300, preview information containing information on a plurality of traveling sections on the scheduled traveling route from the current position of the vehicle 1 to the destination. When the preview information is acquired from the navigation ECU 350, the HV-ECU 300 sets a traveling schedule by assigning any control mode out of the CD mode and the CS mode to each of the traveling sections on the scheduled traveling route to the destination in the preview information. In this embodiment, the HV-ECU 300 divides the scheduled traveling route into the traveling sections by, for example, setting the nodes on the scheduled traveling route as division points of the traveling sections and setting the links as the traveling sections.

The HV-ECU 300 acquires the preview information updated by the navigation ECU 350, and calculates energy consumptions En in the traveling sections on the scheduled traveling route based on the acquired preview information. For example, the HV-ECU 300 calculates the energy consumptions En in the traveling sections by using load information (speed information, power information, and gradient information), road category information, information on whether a traffic jam occurs, and/or distance information in the preview information. For example, the HV-ECU 300 may calculate the energy consumptions En in the traveling sections by using a vehicle weight based on the number of occupants of the vehicle 1 in addition to the preview information. For example, the energy consumption En indicates energy required for the vehicle 1 to travel through a target traveling section at a vehicle speed corresponding to a speed limit or to a speed during a traffic jam.

For example, the HV-ECU 300 assigns the CD mode or the CS mode to each of the traveling sections so that the SOC of the battery 100 reaches a value smaller than the predetermined value when the vehicle 1 arrives at the destination. That is, the HV-ECU 300 sets the traveling schedule so that the electric power in the battery 100 is used up when the vehicle 1 arrives at the destination. For example, the state in which the electric power in the battery 100 is used up means that the SOC of the battery 100 reaches a value equal to or smaller than the predetermined value.

More specifically, when the preview information is received from the navigation ECU 350 (the destination is set or the predetermined period elapses), the HV-ECU 300 calculates a sum Esum of the energy consumptions En in the traveling sections on the scheduled traveling route (hereinafter referred to also as “total energy consumption”). When the traveling sections on the scheduled traveling route include a regenerative section, the HV-ECU 300 calculates the total energy consumption Esum in consideration of regenerative energy in the regenerative section. The regenerative section is a traveling section where the regenerative energy is predicted to be larger than electric energy in the battery 100 that is required for traveling. The HV-ECU 300 calculates energy B corresponding to a difference between a current power storage amount of the battery 100 and the predetermined value (hereinafter referred to also as “remaining battery charge level”).

When the remaining battery charge level B is larger than the total energy consumption Esum, the HV-ECU 300 assigns the CD mode to all the traveling sections. When the remaining battery charge level B is equal to or smaller than the total energy consumption Esum, the HV-ECU 300 assigns the CD mode to the traveling sections in descending order of priority levels preset to the traveling sections. The HV-ECU 300 assigns the CD mode until a total energy consumption Ecd in traveling sections where the CD mode is assigned reaches a value larger than the remaining battery charge level B. The HV-ECU 300 assigns the CS mode to any traveling section where the CD mode cannot be assigned. The HV-ECU 300 sets the traveling schedule by assigning any control mode out of the CD mode and the CS mode to the traveling sections on the scheduled traveling route.

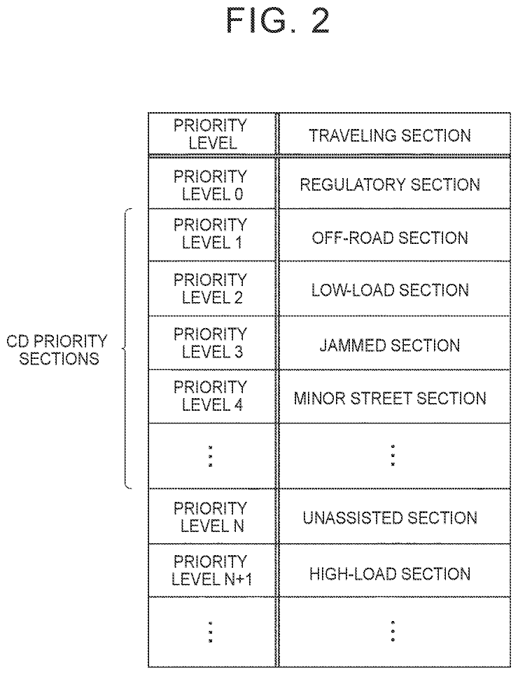

FIG. 2 is a diagram for describing the priority levels to be set to the traveling sections. When setting the traveling schedule, the traveling sections have preset priority levels indicating the order of priority for assignment of the CD mode. FIG. 2 exemplifies priority levels “0” to “4”, a priority level “N”, and a priority level “N+1”. The CD mode is assigned with higher priority to a traveling section where a priority level with a smaller number is set.

In this embodiment, the priority level “0” is set to a regulatory section. Examples of the regulatory section include a traveling section where operation of an engine is prohibited, a traveling section where exhaust gas regulations are set under Euro 1 to Euro 6, and a traveling section where exhaust gas regulations are set under the automobile NOₓ/PM control law. In this embodiment, the priority level “0” is set to the three traveling sections serving as the regulatory section, but may be divided into detailed priority levels. For example, the priority level “0” may be divided into priority levels “0-A”, “0-B”, and “0-C” (the priority level is higher in order of “0-A”→“0-B”→“0-C”). The priority level “0-A” may be set to the traveling section where operation of an engine is prohibited. The priority level “0-B” may be set to the traveling section where exhaust gas regulations are set under Euro 1 to Euro 6. The priority level “0-C” may be set to the traveling section where exhaust gas regulations are set under the automobile NOₓ/PM control law.

The priority level “1” is set to an off-road section. The off-road section is a traveling section whose road category information is “off-road”, and is typified by a parking area where a low vehicle speed and a low load are expected. The priority level “2” is set to a low-load section. The low-load section is a traveling section whose road category information is not “expressway” and where average traveling power required to travel along the section is smaller than average traveling power of a jammed section. The priority level “3” is set to the jammed section. The jammed section is a traveling section whose traffic jam degree is equal to or larger than a predetermined traffic jam threshold. The priority level “4” is set to a minor street section. The minor street section is a traveling section whose road category information is “minor street”. The priority level “N” is set to an unassisted section. The unassisted section is a traveling section that does not belong to the traveling sections having the priority levels described above. The priority level “N+1” is set to a high-load section. The high-load section is a traveling section that satisfies at least one of conditions that the road category information is “expressway” and that the average traveling power is larger than predetermined high-load traveling power.

Traveling sections having the priority level “1” to a priority level “N−1” may hereinafter be referred to as “CD priority sections”. Traveling sections having the priority level “N” and other subsequent priority levels may hereinafter be referred to as “sections except CD priority sections”. The setting of the priority levels to the traveling sections and the setting of the regulatory section, the CD priority sections, and the sections except the CD priority sections are not limited to those in the example described above, and may be made as appropriate. The regulatory section according to this embodiment is an example of “first section” of the present disclosure. The CD priority section according to this embodiment is an example of “second section” of the present disclosure. The section except the CD priority sections according to this embodiment is an example of “third section” of the present disclosure.

The HV-ECU 300 sets the traveling schedule based on the priority levels to assign the CD mode as a control mode of a traveling section having a high priority level. In the regulatory section, it is important to travel without operating the engine 14. By setting the priority level “0” to the regulatory section, it is possible to set a traveling schedule in which the CD mode is assigned to the regulatory section.

A power consumption of the battery 100 in the traveling schedule may differ from an actual power consumption of the battery 100. When electric power equal to or larger than expected is consumed in a traveling section behind the regulatory section, the electric power in the battery 100 may be exhausted and the engine 14 may operate in the regulatory section.

In this embodiment, when the scheduled traveling route to the destination includes the regulatory section, a suppression process for suppressing consumption of the electric power in the battery 100 (first setting process) is executed to suppress the operation of the engine 14 in the regulatory section. In the first setting process, the HV-ECU 300 assigns the CD mode in order of the regulatory section having a high priority level, the CD priority sections, and the sections except the CD priority sections to set the traveling schedule. In the CD priority sections, the CD mode is assigned in order of the off-road section, the low-load section, the jammed section, the minor street section, . . . based on the priority levels. Also in the sections except the CD priority sections, the CD mode is assigned in order of the unassisted section, the high-load section, . . . based on the priority levels. In the assignment of the CD mode to the traveling sections in the orders described above, the HV-ECU 300 terminates the assignment of the CD mode when the remaining battery charge level B reaches a value smaller than the total energy consumption Ecd in the traveling sections where the CD mode is assigned. The HV-ECU 300 reassigns the CS mode as a control mode of the traveling section where the CD mode is assigned last. By reassigning the CS mode as the control mode of the traveling section where the CD mode is assigned last, the traveling schedule includes one more traveling section where the CS mode is assigned than that in a case without the reassignment. Therefore, the traveling schedule has a reserve capacity for the electric power in the battery 100, thereby suppressing exhaustion of the electric power in the battery 100 in the regulatory section.

The HV-ECU 300 executes the first setting process only when the scheduled traveling route to the destination includes the regulatory section. When the scheduled traveling route to the destination does not include the regulatory section, the HV-ECU 300 sets the traveling schedule so that the electric power in the battery 100 is used up. Therefore, the vehicle 1 can travel by using as much electric power in the battery 100 as possible, thereby reducing running costs of the vehicle 1. When the scheduled traveling route to the destination includes the regulatory section, the HV-ECU 300 sets the traveling schedule to secure a surplus of the electric power in the battery 100. Therefore, it is possible to reduce the occurrence of a case where the electric power in the battery 100 is exhausted and the engine 14 operates in the regulatory section. For example, the securement of a surplus of the electric power in the battery 100 means that the SOC of the battery 100 is kept larger than the predetermined value.

The traveling assistance control is described below in detail with reference to a flowchart of processes to be executed by the HV-ECU 300.

### Processes to be Executed by HV-ECU

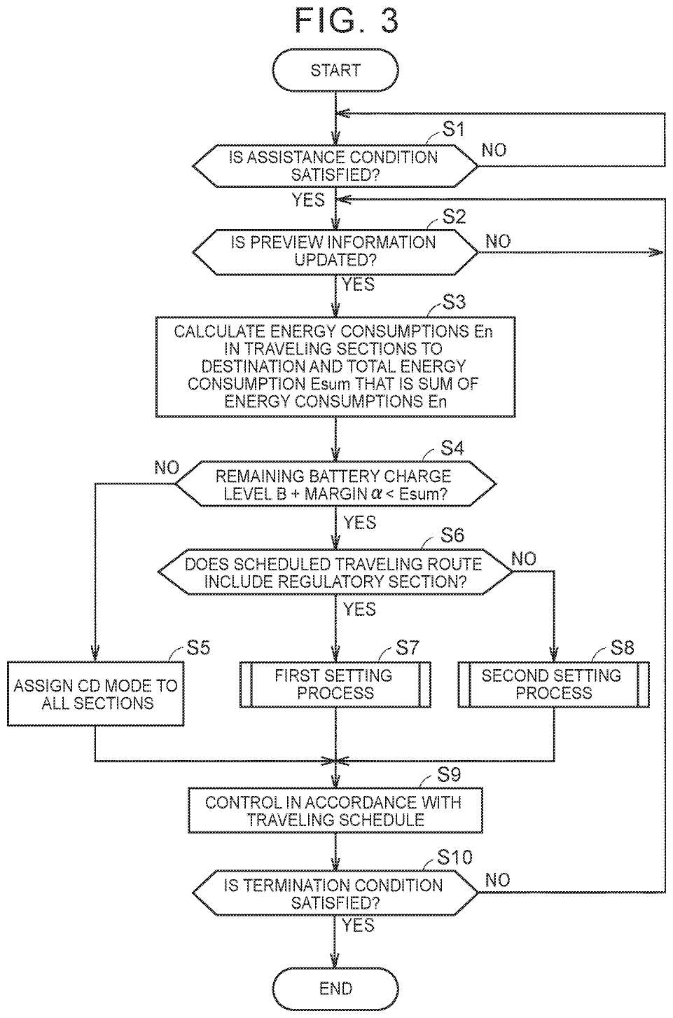

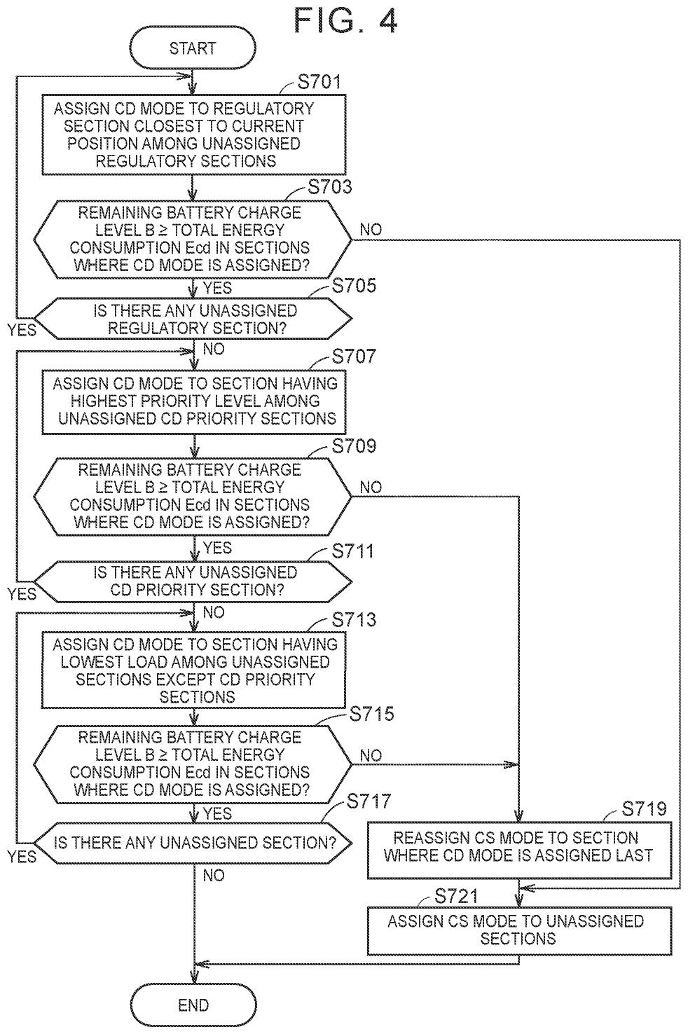

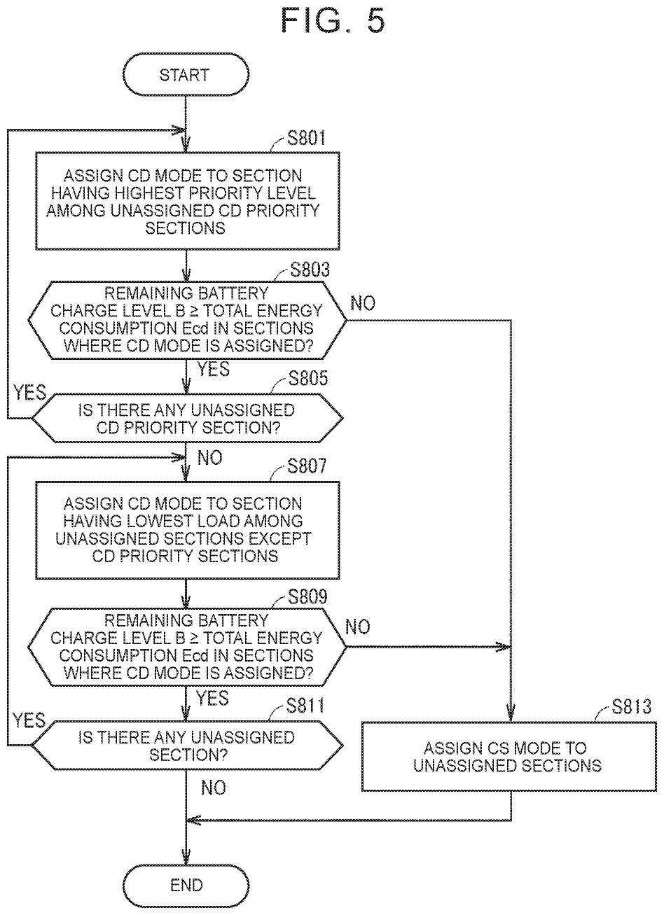

FIG. 3 is a flowchart illustrating a processing procedure of the traveling assistance control. Processes in this flowchart are started by the HV-ECU 300 along with activation of the vehicle 1. Description is given of a case where steps illustrated in FIG. 3 and in FIG. 4 and FIG. 5 (“Step” is hereinafter abbreviated as “S”) are implemented through a software process by the HV-ECU 300. The steps may partially or entirely be implemented by hardware (electronic circuit) manufactured in the HV-ECU 300.

In S1, the HV-ECU 300 determines whether an assistance condition for determining whether to execute the traveling assistance control is satisfied. Examples of the assistance condition include a condition that a destination is set and a scheduled traveling route to the destination is set. That is, whether the assistance condition is satisfied can be determined based on whether preview information is received from the navigation ECU 350. In addition to or in place of the condition described above, the assistance condition may include, for example, a condition that the system of the vehicle 1 has no abnormality. The assistance condition may also include a condition that the SOC of the battery 100 is equal to or larger than a specified value, or a condition that the vehicle 1 is traveling on the route.

When the assistance condition is not satisfied (“NO” in S1), the HV-ECU 300 waits for the satisfaction of the assistance condition. When the assistance condition is satisfied (“YES” in S1), the HV-ECU 300 advances the processes to S2. When the assistance condition is satisfied, processes of S2 to S10 are repeated in every predetermined period (for example, every time interval of several minutes) until a termination condition is satisfied in S10 as described later. The HV-ECU 300 starts counting along with execution of the process of S2, and resets the count every time the predetermined period elapses.

In S2, the HV-ECU 300 determines whether preview information is received from the navigation ECU 350. When the preview information is not received (“NO” in S2), the HV-ECU 300 waits for the reception of the preview information. When the preview information is received (“YES” in S2), the HV-ECU 300 advances the processes to S3.

In S3, the HV-ECU 300 calculates energy consumptions En in a plurality of traveling sections on the scheduled traveling route based on various types of information in the preview information. The HV-ECU 300 calculates a total energy consumption Esum that is the sum of the energy consumptions En in the traveling sections.

In S4, the HV-ECU 300 determines whether the CD mode can be assigned to all the traveling sections on the scheduled traveling route. Specifically, the HV-ECU 300 calculates a remaining battery charge level B based on a current SOC of the battery 100. The HV-ECU 300 compares the total energy consumption Esum calculated in S3 and a value obtained by adding a margin α to the remaining battery charge level B. The margin a is added to the remaining battery charge level B in the expectation that the electric power in the battery 100 is used up when the vehicle 1 arrives at the destination. For example, the margin α can be determined based on specifications of the vehicle 1 and the battery 100, or based on results of experiment or simulation. The value of the margin α may be “zero”. When B+α≥Esum is satisfied, that is, the value obtained by adding the margin α to the remaining battery charge level B is equal to or larger than the total energy consumption Esum (“NO” in S4), the HV-ECU 300 advances the processes to S5. When B+α<Esum is satisfied, that is, the value obtained by adding the margin α to the remaining battery charge level B is smaller than the total energy consumption Esum (“YES” in S4), the HV-ECU 300 advances the processes to S6.

In S5, the HV-ECU 300 assigns the CD mode to all the traveling sections on the scheduled traveling route because the CD mode can be assigned to all the traveling sections when B+α≥Esum is satisfied. The HV-ECU 300 advances the processes to S9.

In S6, the HV-ECU 300 determines whether the scheduled traveling route to the destination includes the regulatory section. When the scheduled traveling route includes the regulatory section (“YES” in S6), the HV-ECU 300 advances the processes to S7. When the scheduled traveling route does not include the regulatory section (“NO” in S6), the HV-ECU 300 advances the processes to S8.

FIG. 4 is a flowchart illustrating a procedure of the first setting process of S7. In S701, the HV-ECU 300 assigns the CD mode to a regulatory section closest to a current position among regulatory sections where the control mode (CD mode or CS mode) is unassigned.

In S703, the HV-ECU 300 determines whether the remaining battery charge level B is equal to or larger than a total energy consumption Ecd in the traveling sections where the CD mode is assigned. When the remaining battery charge level B is equal to or larger than the total energy consumption Ecd (“YES” in S703), the remaining battery charge level B has a reserve capacity, and the CD mode can be assigned to other traveling sections where the control mode is unassigned. Therefore, the HV-ECU 300 advances the processes to S705. When the remaining battery charge level B is smaller than the total energy consumption Ecd (“NO” in S703), the CD mode cannot be assigned to any other traveling sections. Therefore, the HV-ECU 300 advances the processes to S721.

In S705, the HV-ECU 300 determines whether there is any regulatory section where the control mode is unassigned. When there is a regulatory section where the control mode is unassigned (“YES” in S705), the HV-ECU 300 returns the processes to S701 to assign the CD mode to the regulatory section where the control mode is unassigned. When there is no regulatory section where the control mode is unassigned, that is, the CD mode is assigned to all the regulatory sections on the scheduled traveling route (“NO” in S705), the HV-ECU 300 advances the processes to S707.

In S707, the HV-ECU 300 assigns the CD mode to a traveling section having the highest priority level among the CD priority sections where the control mode is unassigned. When a plurality of traveling sections (CD priority sections) has the same priority level, a CD priority section closest to the current position is selected and the CD mode is assigned to the selected CD priority section.

In S709, the HV-ECU 300 determines whether the remaining battery charge level B is equal to or larger than a total energy consumption Ecd in the traveling sections where the CD mode is assigned. When the remaining battery charge level B is equal to or larger than the total energy consumption Ecd (“YES” in S709), the HV-ECU 300 advances the processes to S711. When the remaining battery charge level B is smaller than the total energy consumption Ecd (“NO” in S709), the HV-ECU 300 advances the processes to S719.

In S711, the HV-ECU 300 determines whether there is any CD priority section where the control mode is unassigned. When there is a CD priority section where the control mode is unassigned (“YES” in S711), the HV-ECU 300 returns the processes to S707 to assign the CD mode to the CD priority section where the control mode is unassigned. When there is no CD priority section where the control mode is unassigned, that is, the CD mode is assigned to all the CD priority sections on the scheduled traveling route (“NO” in S711), the HV-ECU 300 advances the processes to S713.

In S713, the HV-ECU 300 assigns the CD mode to a traveling section having the lowest load among the sections where the control mode is unassigned except the CD priority sections. When a plurality of traveling sections (except the CD priority sections) has the same load, a traveling section having the highest priority level is selected and the CD mode is assigned to the selected section. When the priority levels are the same, a traveling section closest to the current position may be selected. In S713, the HV-ECU 300 may assign the CD mode to a traveling section having the highest priority level among the sections where the control mode is unassigned except the CD priority sections. When a plurality of traveling sections has the same priority level, a traveling section having the lowest load may be selected and the CD mode may be assigned to the selected section.

In S715, the HV-ECU 300 determines whether the remaining battery charge level B is equal to or larger than a total energy consumption Ecd in the traveling sections where the CD mode is assigned. When the remaining battery charge level B is equal to or larger than the total energy consumption Ecd (“YES” in S715), the HV-ECU 300 advances the processes to S717. When the remaining battery charge level B is smaller than the total energy consumption Ecd (“NO” in S715), the HV-ECU 300 advances the processes to S719.

In S717, the HV-ECU 300 determines whether there is any traveling section where the control mode is unassigned. When there is a traveling section where the control mode is unassigned (“YES” in S717), the HV-ECU 300 returns the processes to S713 to assign the CD mode to the traveling section where the control mode is unassigned. When there is no traveling section where the control mode is unassigned, that is, the CD mode is assigned to all the traveling sections on the scheduled traveling route (“NO” in S717), the HV-ECU 300 terminates the first setting process.

In S719, the HV-ECU 300 reassigns the CS mode as a control mode of a traveling section where the CD mode is assigned last through the processes of S701 to S719. That is, the HV-ECU 300 changes the control mode of the traveling section where the CD mode is assigned last from the CD mode to the CS mode.

In S721, the HV-ECU 300 assigns the CS mode to all the traveling sections where the control mode is unassigned. The HV-ECU 300 terminates the first setting process.

In the first setting process described above, the control mode of the traveling section where the CD mode is assigned last is changed from the CD mode to the CS mode through the process of S719. Therefore, the electric power in the battery 100 has a reserve capacity. By switching the control modes in accordance with this traveling schedule, the exhaustion of the electric power in the battery 100 can be suppressed in the regulatory section.

FIG. 5 is a flowchart illustrating a procedure of a second setting process of S8. In S801, the HV-ECU 300 assigns the CD mode to a traveling section having the highest priority level among the CD priority sections where the control mode is unassigned. When a plurality of traveling sections (CD priority sections) has the same priority level, a CD priority section closest to the current position is selected and the CD mode is assigned to the selected CD priority section.

In S803, the HV-ECU 300 determines whether the remaining battery charge level B is equal to or larger than a total energy consumption Ecd in the traveling sections where the CD mode is assigned. When the remaining battery charge level B is equal to or larger than the total energy consumption Ecd (“YES” in S803), the remaining battery charge level B has a reserve capacity, and the CD mode can be assigned to other traveling sections where the control mode is unassigned. Therefore, the HV-ECU 300 advances the processes to S805. When the remaining battery charge level B is smaller than the total energy consumption Ecd (“NO” in S803), the CD mode cannot be assigned to any other traveling sections. Therefore, the HV-ECU 300 advances the processes to S813.

In S805, the HV-ECU 300 determines whether there is any CD priority section where the control mode is unassigned. When there is a CD priority section where the control mode is unassigned (“YES” in S805), the HV-ECU 300 returns the processes to S801 to assign the CD mode to the CD priority section where the control mode is unassigned. When there is no CD priority section where the control mode is unassigned, that is, the CD mode is assigned to all the CD priority sections on the scheduled traveling route (“NO” in S805), the HV-ECU 300 advances the processes to S807.

In S807, the HV-ECU 300 assigns the CD mode to a traveling section having the lowest load among the sections where the control mode is unassigned except the CD priority sections. When a plurality of traveling sections (except the CD priority sections) has the same load, a traveling section having the highest priority level is selected and the CD mode is assigned to the selected traveling section. When the priority levels are the same, a traveling section closest to the current position may be selected. In S807, the HV-ECU 300 may assign the CD mode to a traveling section having the highest priority level among the sections where the control mode is unassigned except the CD priority sections. When a plurality of traveling sections has the same priority level in this case, a traveling section having the lowest load may be selected and the CD mode may be assigned to the selected traveling section.

In S809, the HV-ECU 300 determines whether the remaining battery charge level B is equal to or larger than a total energy consumption Ecd in the traveling sections where the CD mode is assigned. When the remaining battery charge level B is equal to or larger than the total energy consumption Ecd (“YES” in S809), the HV-ECU 300 advances the processes to S811. When the remaining battery charge level B is smaller than the total energy consumption Ecd (“NO” in S809), the HV-ECU 300 advances the processes to S813.

In S811, the HV-ECU 300 determines whether there is any traveling section where the control mode is unassigned. When there is a traveling section where the control mode is unassigned (“YES” in S811), the HV-ECU 300 returns the processes to S807 to assign the CD mode to the traveling section where the control mode is unassigned. When there is no traveling section where the control mode is unassigned, that is, the CD mode is assigned to all the traveling sections on the scheduled traveling route (“NO” in S811), the HV-ECU 300 terminates the second setting process.

In S813, the HV-ECU 300 assigns the CS mode to all the traveling sections where the control mode is unassigned. The HV-ECU 300 terminates the second setting process.

As described above, when the scheduled traveling route to the destination does not include the regulatory section, the second setting process is executed to set the traveling schedule so that the electric power in the battery 100 is used up. Therefore, the vehicle 1 can travel by using as much electric power in the battery 100 as possible, thereby reducing the running costs of the vehicle 1.

Referring back to FIG. 3, the HV-ECU 300 executes the process of S9 when the traveling schedule is set in S5, S7, or S8.

In S9, the HV-ECU 300 controls traveling of the vehicle 1 by selecting the control modes in accordance with the traveling schedule set in S5, S7, or S8. While executing the process of S9, the HV-ECU 300 monitors satisfaction of the termination condition by executing the process of S10. The HV-ECU 300 continues the process of S9 until the predetermined period elapses or the termination condition described later is satisfied.

In S10, the HV-ECU 300 determines whether the termination condition is satisfied. Examples of the termination condition include a condition that the vehicle 1 arrives at the destination, a condition that the user of the vehicle 1 cancels route guidance to the destination, and a condition that the vehicle system has an abnormality. That is, the termination condition is satisfied when the vehicle 1 arrives at the destination, the route guidance to the destination is canceled, or the vehicle system has an abnormality. When the termination condition is not satisfied (“NO” in S10), the HV-ECU 300 continues to monitor satisfaction of the termination condition until the predetermined period elapses, and returns the processes to S2 along with the elapse of the predetermined period. When the termination condition is satisfied (“YES” in S10), the HV-ECU 300 terminates the processes.

When the destination is changed or set again, a control signal is output from the navigation ECU 350 to the HV-ECU 300. In this case, the HV-ECU 300 sets a traveling schedule by promptly advancing the processes to S2 irrespective of the predetermined period.

In the traveling assistance control according to the first embodiment described above, when the scheduled traveling route to the destination includes the regulatory section, the traveling schedule is set by executing the suppression process for suppressing the consumption of the electric power in the battery 100 (first setting process), thereby suppressing the operation of the engine 14 in the regulatory section. Specifically, in the first setting process for setting the traveling schedule when the scheduled traveling route to the destination includes the regulatory section, the CD mode is assigned to the traveling sections until the remaining battery charge level B reaches a value smaller than the total energy consumption Ecd in the traveling sections where the CD mode is assigned. The CS mode is reassigned as the control mode of the traveling section where the CD mode is assigned last. By reassigning the CS mode as the control mode of the traveling section where the CD mode is assigned last, the traveling schedule includes one more traveling section where the CS mode is assigned than that in a case without the reassignment. Therefore, the consumption of the electric power in the battery 100 is suppressed, thereby suppressing the exhaustion of the electric power in the battery 100 in the regulatory section. The “first setting process” according to this embodiment is an example of “first process” of the present disclosure.

When the scheduled traveling route to the destination does not include the regulatory section, the second setting process is executed to set the traveling schedule so that the electric power in the battery 100 is used up. Therefore, the vehicle 1 can travel by using as much electric power in the battery 100 as possible, thereby reducing the running costs of the vehicle 1.

### Second Embodiment

The first embodiment is directed to the example in which, when the scheduled traveling route to the destination includes the regulatory section, the traveling schedule is set by executing the first setting process as the suppression process for suppressing the consumption of the electric power in the battery 100, thereby suppressing the exhaustion of the electric power in the battery 100 in the regulatory section. The second embodiment is directed to an example in which a suspension process for suspending the traveling assistance control is executed as the suppression process for suppressing the consumption of the electric power in the battery 100, thereby suppressing the exhaustion of the electric power in the battery 100 in the regulatory section. The suspension process according to the second embodiment is an example of “second process” of the present disclosure.

Referring to FIG. 1, a vehicle 1A according to the second embodiment differs from the vehicle 1 according to the first embodiment in that the HV-ECU 300 is changed to an HV-ECU 300A. The other configuration of the vehicle 1A is similar to that of the vehicle 1, and therefore its description is not repeated.

When a suspension condition is satisfied, the HV-ECU 300A according to the second embodiment suspends the traveling assistance control until an ending condition is satisfied. The suspension condition is satisfied under the expectation that the power consumption of the battery 100 is difficult to predict accurately. Specifically, the suspension condition includes (1) a condition that the vehicle 1A enters an off-road section and/or (2) a condition that the temperature TB of the battery 100 is equal to or lower than a threshold temperature. That is, the suspension condition is satisfied when the vehicle 1A enters the off-road section outside the scheduled traveling route or the temperature of the battery 100 is equal to or lower than the threshold temperature. In the off-road section, the consumption of the electric power in the battery 100 may be difficult to predict. When the temperature TB of the battery 100 is lower than the threshold temperature, the charging/discharging efficiency of the battery 100 may decrease and the consumption of the electric power in the battery 100 may be difficult to predict. By setting the suspension condition to the case where the consumption of the electric power in the battery 100 is difficult to predict, it is possible to suppress power consumption of the battery 100 that is larger than expected. In FIG. 2 of the first embodiment, the off-road section is described as the traveling section having the priority level “1”. When the suspension condition includes the condition (1), the priority level is not set to the off-road section. The suspension condition may include (3) a condition that the engine 14 continuously operates for a predetermined period (for example, several minutes) during traveling in the CD mode.

While the traveling assistance control is suspended (that is, a route to a destination is set and the suspension condition is satisfied), the HV-ECU 300A executes the suspension process. Specifically, while the traveling assistance control is suspended, the HV-ECU 300A determines, in every control period, whether a scheduled traveling route from a current position to the destination includes the regulatory section. When the scheduled traveling route ahead does not include the regulatory section, the HV-ECU 300A controls the vehicle 1A by setting the control mode to the CD mode. When the scheduled traveling route ahead includes the regulatory section, the HV-ECU 300A determines whether a current traveling section is the regulatory section. When the current traveling section is not the regulatory section, the HV-ECU 300A controls the vehicle 1A by setting the control mode to the CS mode. When the current traveling section is the regulatory section, the HV-ECU 300A controls the vehicle 1A by setting the control mode to the CD mode.

In summary, when the scheduled traveling route ahead includes the regulatory section and the current traveling section is not the regulatory section during the suspension of the traveling assistance control, the HV-ECU 300A controls the vehicle 1A by setting the control mode to the CS mode. Therefore, the power consumption of the battery 100 is suppressed in the current traveling section, thereby suppressing the exhaustion of the electric power in the battery 100 in the regulatory section on the scheduled traveling route ahead. When the scheduled traveling route ahead includes the regulatory section and the current traveling section is the regulatory section during the suspension of the traveling assistance control, the HV-ECU 300A controls the vehicle 1A by setting the control mode to the CD mode. Therefore, the operation of the engine 14 can be suppressed in the regulatory section. When the scheduled traveling route ahead does not include the regulatory section during the suspension of the traveling assistance control, the HV-ECU 300A controls the vehicle 1A by setting the control mode to the CD mode. Therefore, the vehicle 1A can travel by using as much electric power in the battery 100 as possible, thereby reducing the running costs of the vehicle 1A.

### Processes to be Executed by HV-ECU

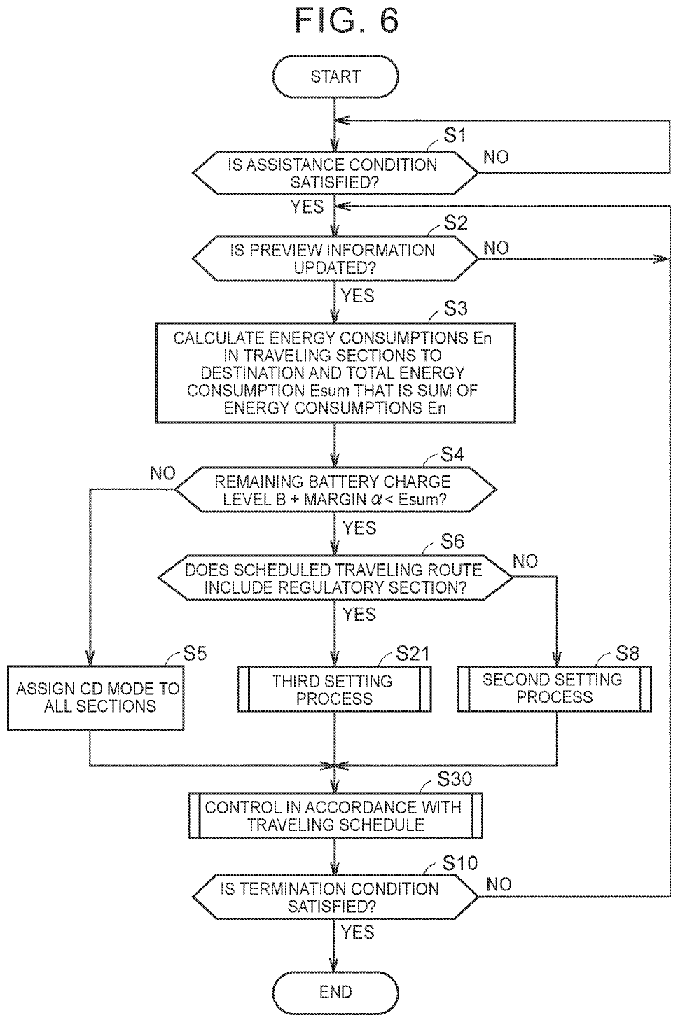

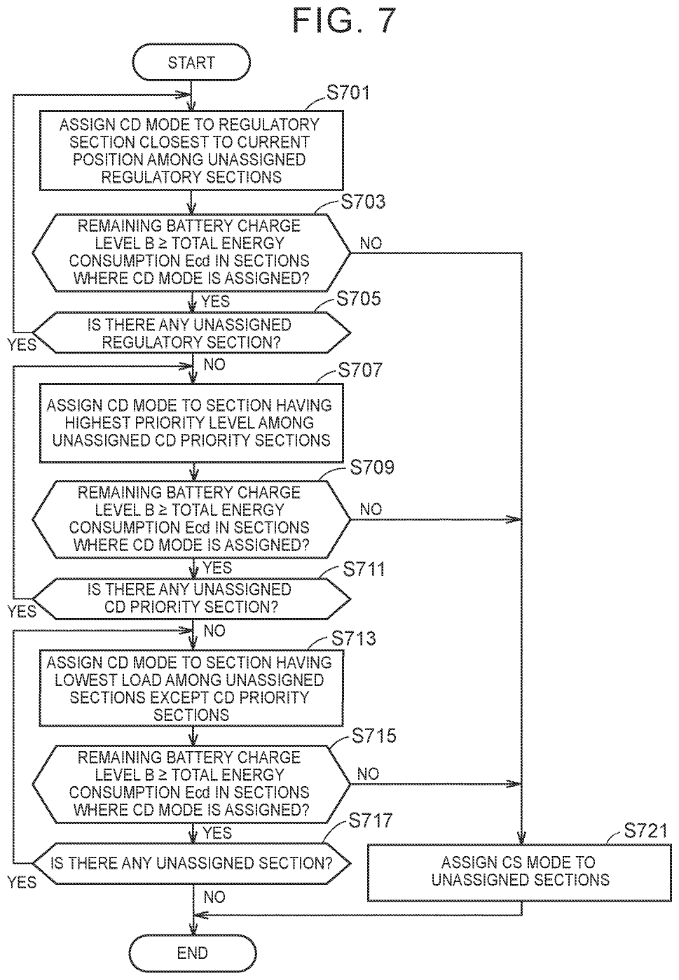

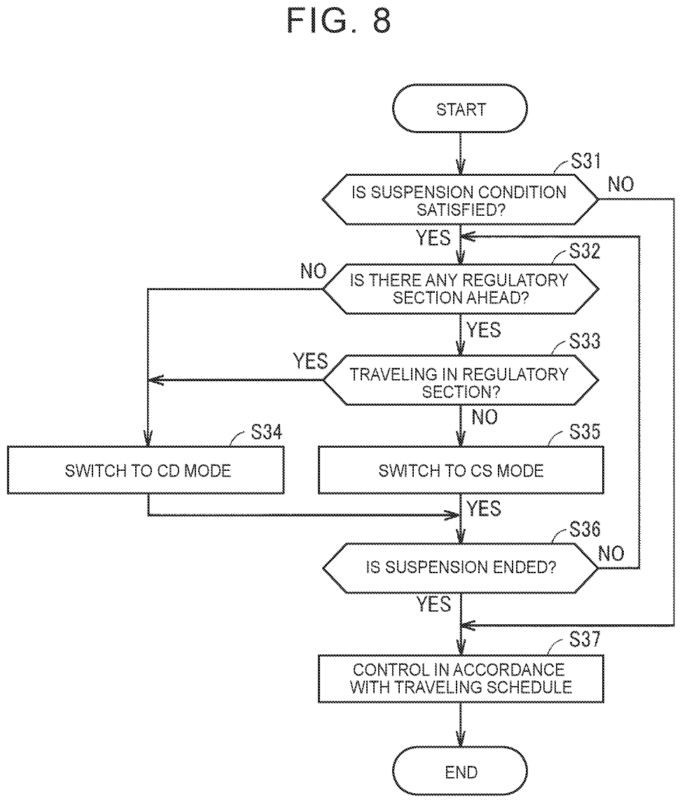

FIG. 6 is a flowchart illustrating a processing procedure of the traveling assistance control according to the second embodiment. Processes in this flowchart are started by the HV-ECU 300A along with activation of the vehicle 1A. Description is given of a case where steps illustrated in FIG. 6 and in FIG. 7 and FIG. 8 are implemented through a software process by the HV-ECU 300A. The steps may partially or entirely be implemented by hardware (electronic circuit) manufactured in the HV-ECU 300A.

The flowchart of FIG. 6 differs from the flowchart of FIG. 3 in that S7 is replaced with S21 and S9 is replaced with S30. The other processes in the flowchart of FIG. 6 are similar to the processes in the flowchart of FIG. 3. Therefore, the same step numbers are assigned and their description is not repeated.

When the CD mode cannot be assigned to all the traveling sections on the scheduled traveling route (“YES” in S4) and the scheduled traveling route to the destination includes the regulatory section (“YES” in S6), the HV-ECU 300A advances the processes to S21 to execute a third setting process.

FIG. 7 is a flowchart illustrating a procedure of the third setting process of S21. The third setting process differs from the first setting process of FIG. 4 in that the process of S719 is omitted. That is, in the third setting process, the traveling schedule is set so as not to generate a surplus of the electric power in the battery 100 by assigning the CD mode to the traveling sections until the remaining battery charge level B reaches a value smaller than the total energy consumption Ecd in the traveling sections where the CD mode is assigned. Processes of individual steps in the flowchart of FIG. 7 are described in FIG. 4. Therefore, the same step numbers as those in the flowchart of FIG. 4 are assigned and their description is not repeated.

Referring back to FIG. 6, the HV-ECU 300A executes a process of S30 when the traveling schedule is set in S5, S8, or S21. In S30, the HV-ECU 300A controls the vehicle 1A by selecting the control modes in accordance with the traveling schedule set in S5, S8, or S21.

FIG. 8 is a flowchart illustrating details of the process of S30. Processes of S32 to S36 in FIG. 8 are examples of the suspension process.

In S31, the HV-ECU 300A determines whether the suspension condition is satisfied. When the suspension condition is not satisfied (“NO” in S31), the HV-ECU 300A advances the processes to S37. When the suspension condition is satisfied (“YES” in S31), the HV-ECU 300A advances the processes to S32.

In S32, the HV-ECU 300A determines whether the scheduled traveling route ahead includes the regulatory section. When the scheduled traveling route ahead includes the regulatory section (“YES” in S32), the HV-ECU 300A advances the processes to S33. When the scheduled traveling route ahead does not include the regulatory section (“NO” in S32), the HV-ECU 300A advances the processes to S34.

In S33, the HV-ECU 300A determines whether a current traveling section is the regulatory section. When the current traveling section is the regulatory section (“YES” in S33), the HV-ECU 300A advances the processes to S34. When the current traveling section is not the regulatory section (“NO” in S33), the HV-ECU 300A advances the processes to S35.

In S34, the HV-ECU 300A controls the engine 14, the first MG 10, and the second MG 12 by setting the control mode to the CD mode.

In S35, the HV-ECU 300A controls the engine 14, the first MG 10, and the second MG 12 by setting the control mode to the CS mode.

In S36, the HV-ECU 300A determines whether the ending condition is satisfied. The ending condition is a condition for resuming the currently suspended traveling assistance control. The ending condition varies depending on the satisfied suspension condition. For example, when the satisfied suspension condition is that (1) the vehicle 1A enters the off-road section, the ending condition is that the vehicle 1A exits the off-road section. For example, when the satisfied suspension condition is that (2) the temperature TB of the battery 100 is equal to or lower than the threshold temperature, the ending condition is that the temperature TB of the battery 100 is higher than the threshold temperature. For example, when the satisfied suspension condition is that (3) the engine 14 continuously operates for the predetermined period during traveling in the CD mode, the ending condition is that the engine 14 is stopped. When the ending condition is not satisfied (“NO” in S36), the HV-ECU 300A returns the processes to S32. When the ending condition is satisfied (“YES” in S36), the HV-ECU 300A advances the processes to S37.

In S37, the HV-ECU 300A selects the control modes in accordance with the traveling schedule, and controls the engine 14, the first MG 10, and the second MG 12 in the selected control modes.

In the traveling assistance control according to the second embodiment described above, when the suspension condition is satisfied, the suspension process for suspending the traveling assistance control is executed as the suppression process for suppressing the consumption of the electric power in the battery 100, thereby suppressing the exhaustion of the electric power in the battery 100 in the regulatory section. When the scheduled traveling route from the current position to the destination includes the regulatory section during the suspension of the traveling assistance control, the vehicle 1A is controlled by setting the control mode to the CS mode unless the current traveling section is the regulatory section. Therefore, the power consumption of the battery 100 is suppressed in the current traveling section, thereby suppressing the exhaustion of the electric power in the battery 100 in the regulatory section on the scheduled traveling route ahead. When the scheduled traveling route from the current position to the destination includes the regulatory section and the current traveling section is the regulatory section during the suspension of the traveling assistance control, the vehicle 1A is controlled by setting the control mode to the CD mode. Therefore, the operation of the engine 14 can be suppressed in the regulatory section. When the scheduled traveling route from the current position to the destination does not include the regulatory section during the suspension of the traveling assistance control, the vehicle 1A is controlled by setting the control mode to the CD mode. Therefore, the vehicle 1A can travel by using as much electric power in the battery 100 as possible, thereby reducing the running costs of the vehicle 1A.

### Modified Example 1

The first embodiment and the second embodiment may be combined together. Specifically, (1) the first setting process may be executed when the CD mode cannot be assigned to all the traveling sections on the scheduled traveling route and the scheduled traveling route to the destination includes the regulatory section, and (2) the suspension process may be executed when the suspension condition is satisfied. When the scheduled traveling route from the current position to the destination includes the regulatory section during the suspension of the traveling assistance control, traveling control may be executed so that the vehicle travels in the CS mode unless the current traveling section is the regulatory section.

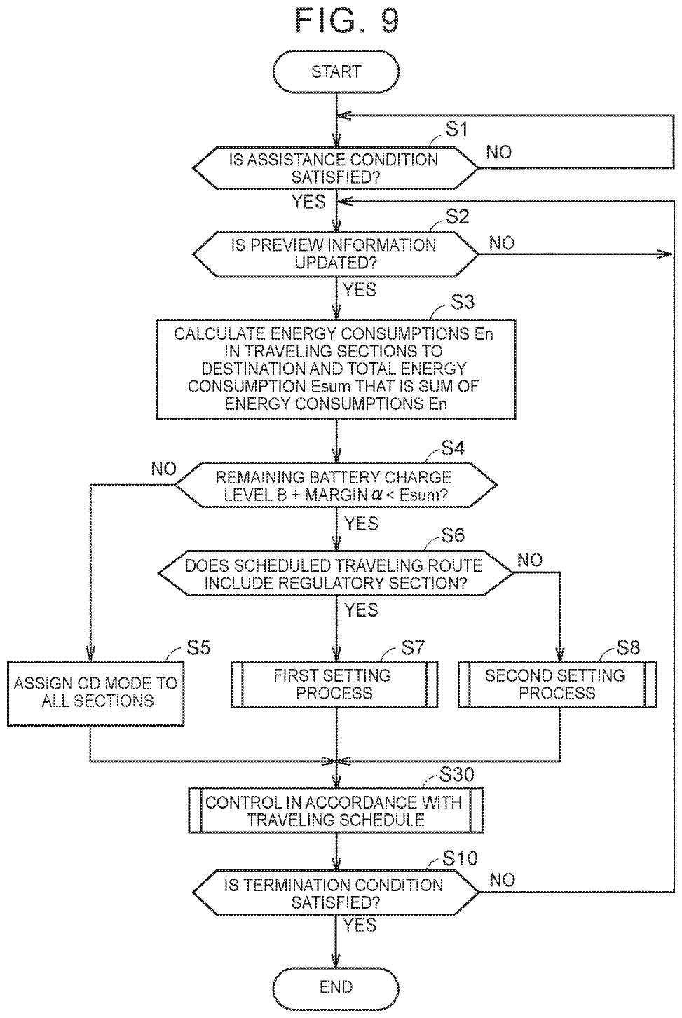

FIG. 9 is a flowchart illustrating a processing procedure of the traveling assistance control in Modified Example 1. Details of processes in the flowchart of FIG. 9 are similar to the processes described in the first and second embodiments. Therefore, the same step numbers are assigned and their description is not repeated.

According to Modified Example 1, when the scheduled traveling route to the destination includes the regulatory section, the traveling schedule is set to secure a surplus of the electric power in the battery 100 through the first setting process, thereby suppressing the operation of the engine 14 in the regulatory section. When the suspension condition is satisfied, the suspension process is executed to suspend the traveling assistance control. When the scheduled traveling route from the current position to the destination includes the regulatory section during the suspension of the traveling assistance control, the vehicle 1 is controlled by setting the control mode to the CS mode unless the current traveling section is the regulatory section, thereby suppressing the exhaustion of the electric power in the battery 100 in the regulatory section ahead. According to Modified Example 1, the exhaustion of the electric power in the battery 100 can further be suppressed in the regulatory section.

### Third Embodiment

The first embodiment is directed to the example in which, when the scheduled traveling route to the destination includes the regulatory section, the traveling schedule is set by executing the first setting process as the suppression process for suppressing the consumption of the electric power in the battery 100, thereby suppressing the exhaustion of the electric power in the battery 100 in the regulatory section. The second embodiment is directed to the example in which the suspension process is executed as the suppression process for suppressing the consumption of the electric power in the battery 100, thereby suppressing the exhaustion of the electric power in the battery 100 in the regulatory section. The third embodiment is directed to an example in which the total energy consumption Esum is calculated by executing a calculation process for calculating “zero” as an energy consumption En in a traveling section that is the regulatory section and also the regenerative section, and an addition process for adding a margin β to an energy consumption En in a regulatory section closest to a current position, thereby suppressing the exhaustion of the electric power in the battery 100 in the regulatory section. The calculation process according to the third embodiment is an example of “third process” of the present disclosure. The addition process according to the third embodiment is an example of “fourth process” of the present disclosure.

Referring to FIG. 1, a vehicle 1B according to the third embodiment differs from the vehicle 1 according to the first embodiment in that the HV-ECU 300 is changed to an HV-ECU 300B. The other configuration of the vehicle 1B is similar to that of the vehicle 1, and therefore its description is not repeated.

When preview information is received from the navigation ECU 350, the HV-ECU 300B calculates energy consumptions En in the traveling sections on the scheduled traveling route, and calculates a total energy consumption Esum by summing the energy consumptions En. The traveling sections on the scheduled traveling route may include the regenerative section. As described above, the regenerative section is a traveling section where the regenerative energy is predicted to be larger than the electric energy in the battery 100 that is required for traveling.

The HV-ECU 300B according to the third embodiment executes the calculation process when the scheduled traveling route includes a traveling section that is the regulatory section and also the regenerative section. Specifically, the HV-ECU 300B calculates “zero” as an energy consumption En in the traveling section that is the regulatory section and also the regenerative section. An expected value of the energy consumption En in the regenerative section is a negative value. By calculating “zero” as the energy consumption En, the total energy consumption Esum can be calculated with a margin. In other words, the HV-ECU 300B calculates “zero” as the energy consumption En in the traveling section that is the regulatory section and also the regenerative section to estimate a large energy consumption En in this traveling section, thereby calculating a relatively large total energy consumption Esum. Since the total energy consumption Esum is calculated with the margin, there is a strong possibility that the vehicle 1B arrives at the destination without using up the electric power in the battery 100 even if the traveling schedule is set so that the electric power in the battery 100 is used up when the vehicle 1B arrives at the destination. Therefore, it is possible to reduce the occurrence of a case where the electric power in the battery 100 is exhausted and the engine 14 operates in the regulatory section.

The HV-ECU 300B according to the third embodiment executes the addition process when setting the traveling schedule. Specifically, the HV-ECU 300B adds the margin β to an energy consumption En in a regulatory section closest to the current position. The margin β is added to secure an allowance of the energy consumption En in the regulatory section. For example, the margin β may be a fixed value determined based on results of experiment or simulation. The margin β may be a value determined for each traveling section depending on a distance or a load in the regulatory section.

By adding the margin β to the energy consumption En in the regulatory section closest to the current position, a large energy consumption En is estimated in the regulatory section, thereby calculating a total energy consumption Esum with a margin. Since the total energy consumption Esum is calculated with the margin, there is a strong possibility that the vehicle 1B arrives at the destination without using up the electric power in the battery 100 even if the traveling schedule is set so that the electric power in the battery 100 is used up when the vehicle 1B arrives at the destination. Therefore, it is possible to reduce the occurrence of a case where the electric power in the battery 100 is exhausted and the engine 14 operates in the regulatory section.

### Processes to be Executed by HV-ECU

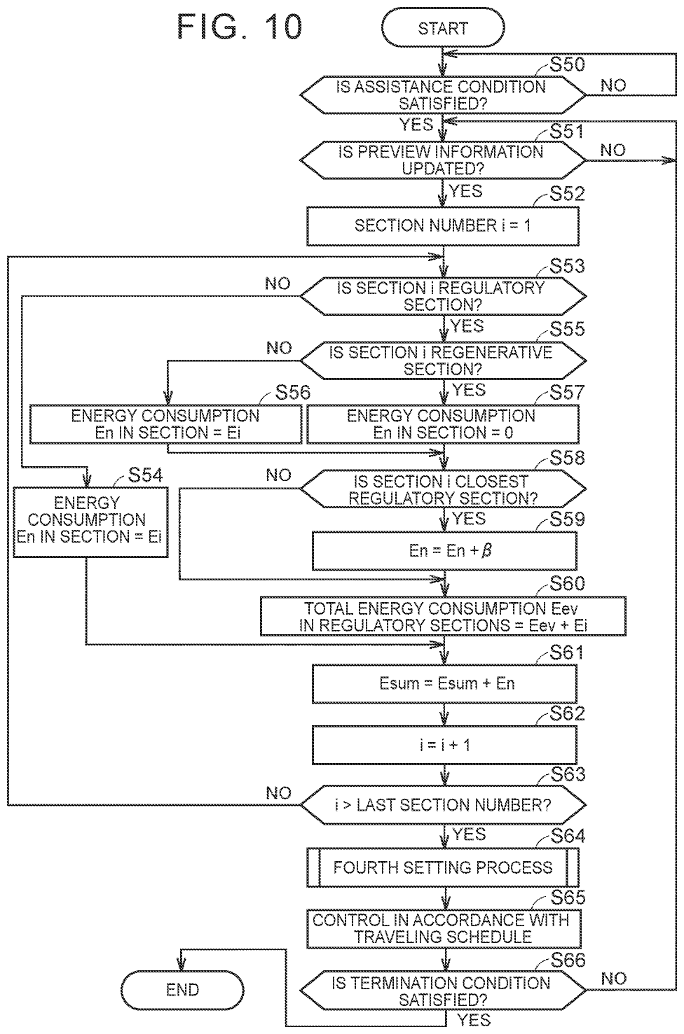

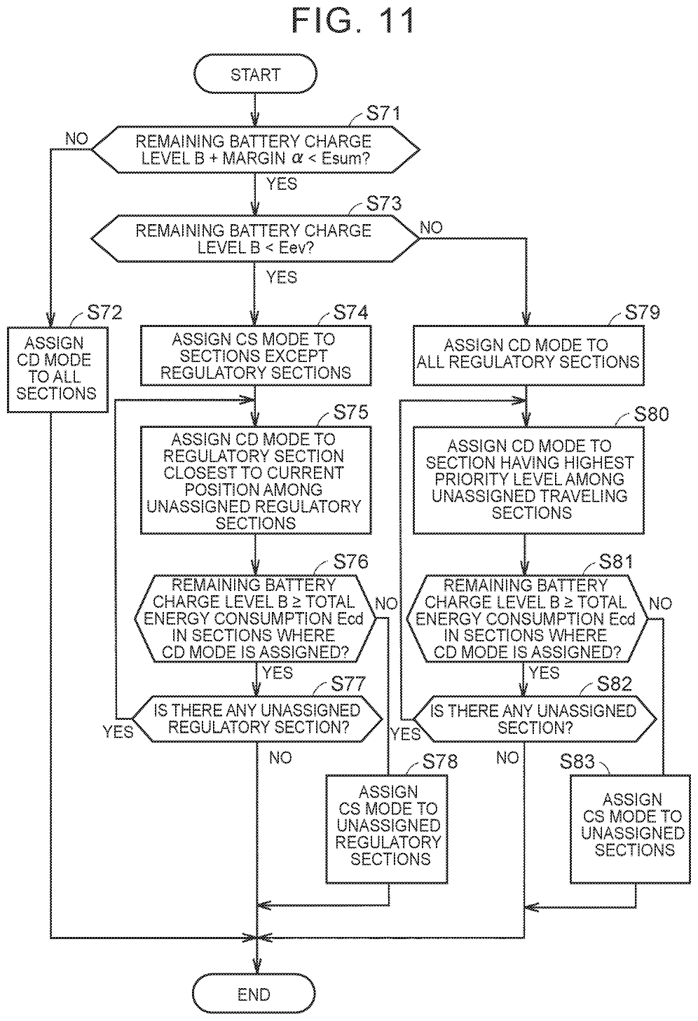

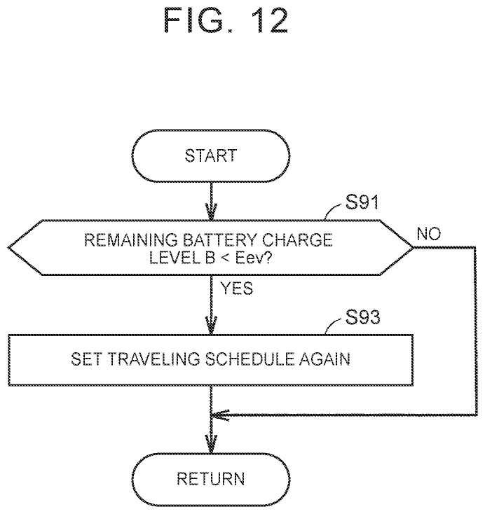

FIG. 10 is a flowchart illustrating a processing procedure of traveling assistance control according to the third embodiment. Processes in this flowchart are started by the HV-ECU 300B along with activation of the vehicle 1B. Description is given of a case where steps illustrated in FIG. 10 and in FIG. 11 and FIG. 12 are implemented through a software process by the HV-ECU 300B. The steps may partially or entirely be implemented by hardware (electronic circuit) manufactured in the HV-ECU 300B. Processes of S53 to S57, S60, and S61 in FIG. 10 are examples of the calculation process. Processes of S58 and S59 in FIG. 10 are examples of the addition process.

Processes of S50 and S51 in the flowchart of FIG. 10 are similar to those of S1 and S2 in the flowchart of FIG. 3, and therefore their description is not repeated. When preview information is received from the navigation ECU 350 (“YES” in S51), the HV-ECU 300B advances the processes to S52.

In S52, the HV-ECU 300B substitutes “1” for a section number i. That is, the HV-ECU 300B assigns a section number i=1 to a current traveling section. The HV-ECU 300B repeats the following processes of S53 to S63 on a plurality of traveling sections on a scheduled traveling route to calculate energy consumptions En in the traveling sections, a total energy consumption Eev in regulatory sections, and a total energy consumption Esum.

In S53, the HV-ECU 300B determines whether the traveling section having the section number i is the regulatory section. When the traveling section having the section number i is not the regulatory section (“NO” in S53), the HV-ECU 300B advances the processes to S54. When the traveling section having the section number i is the regulatory section (“YES” in S53), the HV-ECU 300B advances the processes to S55.

In S54, the HV-ECU 300B calculates an energy consumption En in the traveling section having the section number i based on various types of information in the preview information. For example, the HV-ECU 300B calculates “Ei” as the energy consumption En in the traveling section having the section number i. When the energy consumptions En in the traveling section having the section number i is calculated, the HV-ECU 300B advances the processes to S61.

In S55, the HV-ECU 300B determines whether the traveling section having the section number i is the regenerative section. When the traveling section having the section number i is not the regenerative section (“NO” in S55), the HV-ECU 300B advances the processes to S56. When the traveling section having the section number i is the regenerative section (“YES” in S55), the HV-ECU 300B advances the processes to S57.

In S56, the HV-ECU 300B calculates an energy consumption En in the traveling section having the section number i based on various types of information in the preview information. For example, the HV-ECU 300B calculates “Ei” as the energy consumption En in the traveling section having the section number i. That is, when the traveling section having the section number i is the regulatory section and is not the regenerative section, the HV-ECU 300B calculates “Ei” as the energy consumption En in the traveling section having the section number i based on various types of information in the preview information. The HV-ECU 300B advances the processes to S58.

In S57, the HV-ECU 300B calculates “zero” as the energy consumption En in the traveling section having the section number i. That is, when the traveling section having the section number i is the regulatory section and is also the regenerative section, the HV-ECU 300B calculates “zero” as the energy consumption En in the traveling section having the section number i. The HV-ECU 300B advances the processes to S58.

In S58, the HV-ECU 300B determines whether the traveling section having the section number i is a regulatory section closest to a current position. Specifically, the HV-ECU 300B determines whether the traveling section having the section number i is a regulatory section having the smallest section number among the regulatory sections on the scheduled traveling route. When the traveling section having the section number i is the regulatory section closest to the current position (“YES” in S58), the HV-ECU 300B advances the processes to S59. When the traveling section having the section number i is not the regulatory section closest to the current position (“NO” in S58), the HV-ECU 300B skips the process of S59 and advances the processes to S60.

In S59, the HV-ECU 300B adds the margin β to the energy consumption En in the traveling section having the section number i. That is, when the traveling section having the section number i is the regulatory section and is also the regulatory section closest to the current position, the HV-ECU 300B adds the margin β to the energy consumption En in the traveling section having the section number i.

In S60, the HV-ECU 300B calculates a current total energy consumption Eev in the regulatory sections by adding the energy consumption En in the traveling section having the section number i to a previous total energy consumption Eev in the regulatory sections.

In S61, the HV-ECU 300B calculates a current total energy consumption Esum by adding the energy consumption En in the traveling section having the section number i to a previous total energy consumption Esum.

In S62, the HV-ECU 300B adds “1” to the section number i. In S63, the HV-ECU 300B determines whether the section number i is larger than a number of the last section on the scheduled traveling route. When the section number i is equal to or smaller than the number of the last section (“NO” in S63), the HV-ECU 300B returns the processes to S53 to execute the processes of S53 to S63. When the section number i is larger than the number of the last section (“YES” in S63), the HV-ECU 300B advances the processes to S64 to execute a fourth setting process.

FIG. 11 is a flowchart illustrating a procedure of the fourth setting process of S64. In S71, the HV-ECU 300B determines whether the CD mode can be assigned to all the traveling sections on the scheduled traveling route. Specifically, the HV-ECU 300B compares the total energy consumption Esum and a value obtained by adding the margin α to the remaining battery charge level B. When B+α≥Esum is satisfied, that is, the value obtained by adding the margin α to the remaining battery charge level B is equal to or larger than the total energy consumption Esum (“NO” in S71), the HV-ECU 300B advances the processes to S72. When B+α<Esum is satisfied, that is, the value obtained by adding the margin α to the remaining battery charge level B is smaller than the total energy consumption Esum (“YES” in S71), the HV-ECU 300B advances the processes to S73.

In S72, the HV-ECU 300B assigns the CD mode to all the traveling sections on the scheduled traveling route because the CD mode can be assigned to all the traveling sections when B+α≥Esum is satisfied. The HV-ECU 300B terminates the fourth setting process.

In S73, the HV-ECU 300B compares the remaining battery charge level B and the total energy consumption Eev in the regulatory sections. When the remaining battery charge level B is smaller than the total energy consumption Eev in the regulatory sections (“YES” in S73), the HV-ECU 300B advances the processes to S74. In this case, the CD mode cannot be assigned to all the regulatory sections. When the remaining battery charge level B is equal to or larger than the total energy consumption Eev in the regulatory sections (“NO” in S73), the HV-ECU 300B advances the processes to S79. In this case, the CD mode can be set to all the regulatory sections.

In S74, the HV-ECU 300B first assigns the CS mode as a control mode of traveling sections except the regulatory sections because the CD mode cannot be assigned to all the regulatory sections.

In S75, the HV-ECU 300B assigns the CD mode to a regulatory section closest to the current position among the regulatory sections where the control mode is unassigned.

In S76, the HV-ECU 300B determines whether the remaining battery charge level B is equal to or larger than a total energy consumption Ecd in the traveling sections where the CD mode is assigned. When the remaining battery charge level B is equal to or larger than the total energy consumption Ecd (“YES” in S76), the remaining battery charge level B has a reserve capacity, and the CD mode can be assigned to other regulatory sections. Therefore, the HV-ECU 300B advances the processes to S77. When the remaining battery charge level B is smaller than the total energy consumption Ecd (“NO” in S76), the CD mode cannot be assigned to any other regulatory sections. Therefore, the HV-ECU 300B advances the processes to S78.

In S77, the HV-ECU 300B determines whether there is any regulatory section where the control mode is unassigned. When there is a regulatory section where the control mode is unassigned (“YES” in S77), the HV-ECU 300B returns the processes to S75 to assign the CD mode to the regulatory section where the control mode is unassigned. When there is no regulatory section where the control mode is unassigned, that is, the CD mode is assigned to all the regulatory sections on the scheduled traveling route (“NO” in S77), the HV-ECU 300B terminates the fourth setting process.

In S78, the HV-ECU 300B assigns the CS mode to all the regulatory sections where the control mode is unassigned. The HV-ECU 300B terminates the fourth setting process.

In S79, the HV-ECU 300B assigns the CD mode to all the regulatory sections. In S80, the HV-ECU 300B assigns the CD mode to a traveling section having the highest priority level among the traveling sections where the control mode is unassigned. The HV-ECU 300B first assigns the CD mode to the CD priority sections. When the remaining battery charge level B has a reserve capacity, the HV-ECU 300B assigns the CD mode also to the sections except the CD priority sections. When a plurality of CD priority sections has the same priority level, the HV-ECU 300B selects a CD priority section closest to the current position from among the traveling sections, and assigns the CD mode to the selected CD priority section. Alternatively, when a plurality of CD priority sections has the same priority level, the HV-ECU 300B may select a CD priority section having the lowest traveling load from among the traveling sections, and assign the CD mode to the selected CD priority section. The HV-ECU 300B assigns the CD mode to the sections except the CD priority sections in order from a traveling section having the lowest traveling load.

In S81, the HV-ECU 300B determines whether the remaining battery charge level B is equal to or larger than a total energy consumption Ecd in the traveling sections where the CD mode is assigned. When the remaining battery charge level B is equal to or larger than the total energy consumption Ecd (“YES” in S81), the HV-ECU 300B advances the processes to S82. When the remaining battery charge level B is smaller than the total energy consumption Ecd (“NO” in S81), the HV-ECU 300B advances the processes to S83.

In S82, the HV-ECU 300B determines whether there is any traveling section where the control mode is unassigned. When there is a traveling section where the control mode is unassigned (“YES” in S82), the HV-ECU 300B returns the processes to S80 to assign the CD mode to the traveling section where the control mode is unassigned. When there is no traveling section where the control mode is unassigned (“NO” in S82), the HV-ECU 300B terminates the fourth setting process.

In S83, the HV-ECU 300B assigns the CS mode to all the traveling sections where the control mode is unassigned. The HV-ECU 300B terminates the fourth setting process.

Referring back to FIG. 10, the HV-ECU 300B executes processes of S65 and S66 when the fourth setting process is terminated. The processes of S65 and S66 are similar to the processes of S9 and S10 in the flowchart of FIG. 3, and therefore their description is not repeated.

FIG. 12 is a diagram for describing a process for setting the traveling schedule again. The HV-ECU 300B according to the third embodiment starts the processes in the flowchart of FIG. 10, and also starts processes in the flowchart of FIG. 12 to monitor the remaining battery charge level B. Even though the vehicle 1B is controlled in accordance with the traveling schedule, an actual power consumption of the battery 100 may be larger than a power consumption of the battery 100 that is estimated in the traveling schedule. In this case, the traveling schedule is desirably set again. The HV-ECU 300B monitors the remaining battery charge level B, and determines whether the traveling schedule needs to be set again.

In S91, the HV-ECU 300B determines whether the remaining battery charge level B is smaller than the total energy consumption Eev in the regulatory sections. When the remaining battery charge level B is smaller than the total energy consumption Eev in the regulatory sections, the engine 14 may operate in the regulatory section while the vehicle 1B is traveling in accordance with a current traveling schedule. Therefore, when the remaining battery charge level B is smaller than the total energy consumption Eev in the regulatory sections (“YES” in S91), the HV-ECU 300B advances the processes to S93. When the remaining battery charge level B is equal to or larger than the total energy consumption Eev in the regulatory sections (“NO” in S91), the HV-ECU 300B advances the processes to “Return”.

In S93, the HV-ECU 300B sets the traveling schedule again. Specifically, the HV-ECU 300B advances the processes to S52 in the flowchart of FIG. 10 irrespective of whether the predetermined period elapses. Thus, the traveling schedule is set based on the current remaining battery charge level B.

In the traveling assistance control according to the third embodiment described above, the energy consumption En in the traveling section that is the regulatory section and also the regenerative section is calculated to be “zero” (calculation process) when setting the traveling schedule. Therefore, the total energy consumption Esum is calculated with a margin. Since the total energy consumption Esum is calculated with the margin, there is a strong possibility that the vehicle 1B arrives at the destination without using up the electric power in the battery 100 even if the traveling schedule is set so that the electric power in the battery 100 is used up when the vehicle 1B arrives at the destination. Therefore, it is possible to reduce the occurrence of a case where the electric power in the battery 100 is exhausted and the engine 14 operates in the regulatory section.

In the traveling assistance control according to the third embodiment, the margin β is added to the energy consumption En in the regulatory section closest to the current position (addition process) when setting the traveling schedule. By adding the margin β to the energy consumption En in the regulatory section closest to the current position, the total energy consumption Esum is calculated with a margin. Therefore, there is a strong possibility that the vehicle 1B arrives at the destination without using up the electric power in the battery 100 even if the traveling schedule is set so that the electric power in the battery 100 is used up when the vehicle 1B arrives at the destination. Thus, it is possible to reduce the occurrence of a case where the electric power in the battery 100 is exhausted and the engine 14 operates in the regulatory section.

In the traveling assistance control according to the third embodiment, monitoring is executed as to whether the remaining battery charge level B is smaller than the total energy consumption Eev in the regulatory sections. When the remaining battery charge level B is smaller than the total energy consumption Eev in the regulatory sections, the traveling schedule is promptly set again. Therefore, the traveling schedule is set based on the current remaining battery charge level B. Thus, it is possible to reduce the occurrence of a case where the electric power in the battery 100 is exhausted and the engine 14 operates in the regulatory section.

The HV-ECU 300B may execute only one of the calculation process for calculating “zero” as the energy consumption En in the traveling section that is the regulatory section and also the regenerative section and the addition process for adding the margin β to the energy consumption En in the regulatory section closest to the current position. Even in the case of executing only one of the processes, the exhaustion of the electric power in the battery 100 can be suppressed in the regulatory section as described above. Therefore, the operation of the engine 14 can be suppressed in the regulatory section. The “combination of third embodiment” in Modified Examples 2 to 4 described later includes not only a combination of the configuration in which the calculation process and the addition process are executed together, but also a combination of the configuration in which the calculation process or the addition process is executed alone.

### Modified Example 2

The first embodiment and the third embodiment may be combined together. Specifically, when the processes of S52 to S63 in the flowchart of FIG. 10 according to the third embodiment are referred to as “predetermined process”, the process of S3 in the flowchart of FIG. 3 according to the first embodiment may be changed to the predetermined process. That is, the predetermined process includes the calculation process and the addition process. As described above, the predetermined process may include at least one of the calculation process and the addition process.

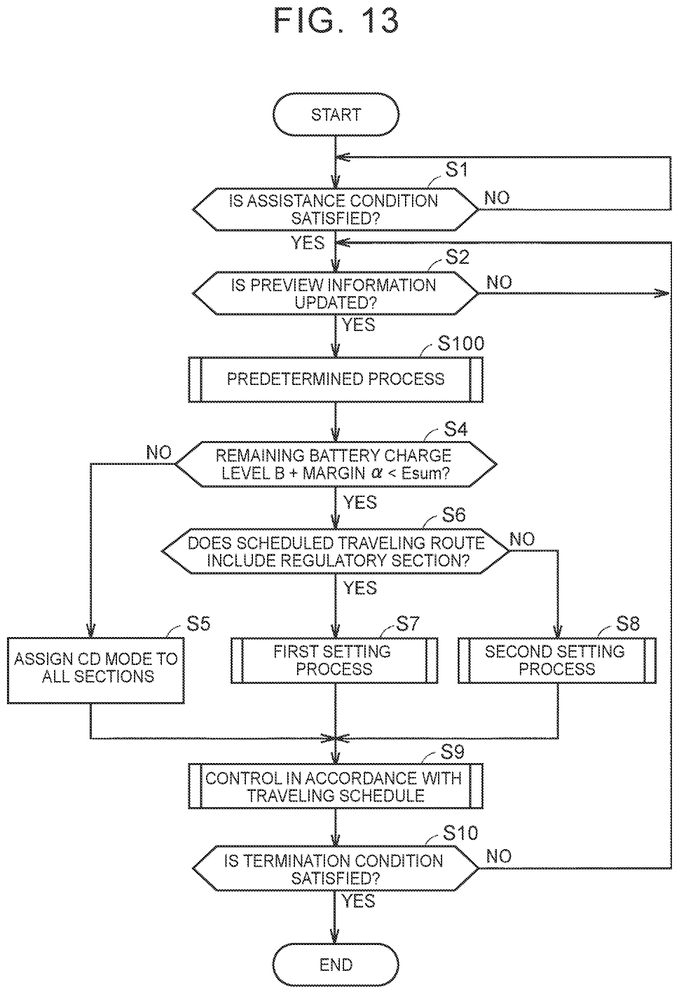

FIG. 13 is a flowchart illustrating a processing procedure of traveling assistance control in Modified Example 2. In the flowchart of FIG. 13, S3 in the flowchart of FIG. 3 is changed to the predetermined process. Details of processes in the flowchart of FIG. 13 are similar to the processes described in the first and third embodiments. Therefore, the same step numbers are assigned and their description is not repeated. The predetermined process is represented by “S100”.

Through the predetermined process, the energy consumption En in the traveling section that is the regulatory section and also the regenerative section is calculated to be “zero”, and the total energy consumption Esum is calculated with a margin. Through the predetermined process, the margin β is added to the energy consumption En in the regulatory section closest to the current position. When the scheduled traveling route to the destination includes the regulatory section, the traveling schedule is set to secure a surplus of the electric power in the battery 100 by executing the first setting process. Therefore, it is possible to further reduce the occurrence of a case where the electric power in the battery 100 is exhausted and the engine 14 operates in the regulatory section.

The processes in the flowchart of FIG. 12 may be executed for monitoring as to whether the remaining battery charge level B is smaller than the total energy consumption Eev in the regulatory sections. When the remaining battery charge level B is smaller than the total energy consumption Eev in the regulatory sections, the traveling schedule is promptly set again. Therefore, the traveling schedule can be set based on the current remaining battery charge level B. Thus, it is possible to reduce the occurrence of a case where the electric power in the battery 100 is exhausted and the engine 14 operates in the regulatory section.

### Modified Example 3

The second embodiment and the third embodiment may be combined together. Specifically, the traveling schedule is set through the processes in the flowchart of FIG. 10 according to the third embodiment, and traveling control is executed in accordance with the traveling schedule. Specifically, through the predetermined process, the energy consumption En in the traveling section that is the regulatory section and also the regenerative section is calculated to be “zero”, and the total energy consumption Esum is calculated with a margin. Through the predetermined process, the margin β is added to the energy consumption En in the regulatory section closest to the current position. The processes in the flowchart of FIG. 8 according to the second embodiment are executed. When the scheduled traveling route from the current position to the destination includes the regulatory section during the suspension of the traveling assistance control, traveling control is executed so that the vehicle travels in the CS mode unless the current traveling section is the regulatory section. Therefore, it is possible to reduce the occurrence of a case where the electric power in the battery 100 is exhausted and the engine 14 operates in the regulatory section.

The processes in the flowchart of FIG. 12 may be executed for monitoring as to whether the remaining battery charge level B is smaller than the total energy consumption Eev in the regulatory sections. When the remaining battery charge level B is smaller than the total energy consumption Eev in the regulatory sections, the traveling schedule is promptly set again. Therefore, the traveling schedule can be set based on the current remaining battery charge level B. Thus, it is possible to reduce the occurrence of a case where the electric power in the battery 100 is exhausted and the engine 14 operates in the regulatory section.

### Modified Example 4

The first embodiment, the second embodiment, and the third embodiment may be combined together. Specifically, the process of S3 in the flowchart of FIG. 3 according to the first embodiment is changed to the predetermined process, and the processes in the flowchart of FIG. 8 are executed together with the processes in the flowchart of FIG. 3. When the scheduled traveling route from the current position to the destination includes the regulatory section during the suspension of the traveling assistance control, traveling control is executed so that the vehicle travels in the CS mode unless the current traveling section is the regulatory section. Therefore, it is possible to reduce the occurrence of a case where the electric power in the battery 100 is exhausted and the engine 14 operates in the regulatory section.

The processes in the flowchart of FIG. 12 may be executed for monitoring as to whether the remaining battery charge level B is smaller than the total energy consumption Eev in the regulatory sections. When the remaining battery charge level B is smaller than the total energy consumption Eev in the regulatory sections, the traveling schedule is promptly set again. Therefore, the traveling schedule can be set based on the current remaining battery charge level B. Thus, it is possible to reduce the occurrence of a case where the electric power in the battery 100 is exhausted and the engine 14 operates in the regulatory section.

### Modified Example 5

When the traveling schedule is set but the remaining battery charge level is smaller than a threshold and the scheduled traveling route ahead includes the regulatory section, the control mode of traveling sections except the regulatory section may be set to the CS mode. Therefore, the operation of the engine 14 can be suppressed in the regulatory section.

Modified Example 5 may be combined with the first, second, and third embodiments and Modified Examples 1, 2, 3, and 4.

It should be understood that the embodiments disclosed herein are illustrative but are not limitative in all respects. The scope of the present disclosure is defined by the claims rather than the description of the embodiments above, and is intended to encompass meanings of equivalents to the elements in the claims and all modifications within the scope of the claims.

What is claimed is:

1. A hybrid vehicle comprising:
an internal combustion engine;
a battery;
an electric motor configured to generate a traveling drive force by using electric power stored in the battery; and
a controller configured to
set a traveling schedule to a destination by assigning any control mode out of a charge depleting mode and a charge sustaining mode to each of a plurality of traveling sections on a scheduled traveling route from a current position to the destination, the traveling sections including at least one of a first section, a second section, and a third section, the first section being a traveling section that requires traveling with the internal combustion engine stopped, the second section being a traveling section that requires assignment of the charge depleting mode, the third section being a traveling section except the first section and the second section,
when setting the traveling schedule, assign the charge depleting mode in order of the first section, the second section, and the third section until a remaining charge level of the battery reaches a value smaller than a sum of energy consumptions in traveling sections where the charge depleting mode is assigned, and assign the charge sustaining mode to traveling sections where the charge depleting mode is not assigned,
execute traveling assistance control for switching the control modes in accordance with the traveling schedule, and
when the traveling sections include the first section, execute a suppression process for suppressing consumption of the electric power in the battery as compared to a case where the traveling sections do not include the first section.

2. The hybrid vehicle according to claim 1, wherein the suppression process includes a first process for setting the traveling schedule by reassigning the charge sustaining mode to at least one of the traveling sections where the charge depleting mode is assigned.

3. The hybrid vehicle according to claim 2, wherein the controller is configured to, when the remaining charge level of the battery is smaller than the sum, set the traveling schedule through the first process by reassigning the charge sustaining mode to a traveling section where the charge depleting mode is assigned last among the traveling sections where the charge depleting mode is assigned in the order of the first section, the second section, and the third section.

4. The hybrid vehicle according to claim 1, wherein:
the suppression process includes a second process for suspending the traveling assistance control when a suspension condition is satisfied; and
the controller is configured to set the control mode to the charge sustaining mode when the traveling sections include the first section and a current traveling section is not the first section during suspension of the traveling assistance control through the second process.

5. The hybrid vehicle according to claim 4, wherein the controller is configured to set the control mode to the charge depleting mode when the current traveling section is the first section during the suspension of the traveling assistance control through the second process.

6. The hybrid vehicle according to claim 4, wherein the suspension condition includes at least one of a condition that the hybrid vehicle enters an off-road section and a condition that a temperature of the battery is lower than a threshold temperature.

7. The hybrid vehicle according to claim 1, wherein the suppression process includes a third process for calculating zero as an energy consumption in a traveling section that is the first section where regenerative energy is larger than a power consumption of the battery when calculating the energy consumptions in the traveling sections.

8. The hybrid vehicle according to claim 1, wherein:
the traveling sections include a plurality of the first sections; and
the suppression process includes a fourth process for adding a predetermined margin to an energy consumption in at least one of the first sections when calculating the energy consumptions in the traveling sections.

9. The hybrid vehicle according to claim 8, wherein the controller is configured to add the predetermined margin to an energy consumption in the first section closest to the current position in the fourth process.

10. The hybrid vehicle according to claim 1, wherein:
the charge depleting mode is a control mode for consuming the electric power stored in the battery; and
the charge sustaining mode is a control mode for keeping a power storage amount of the battery within a predetermined range.
